(19) United States
(12) Patent Application Publication
(10) Pub. No.: US 2026/0019849 A1
(43) Pub. Date: Jan. 15, 2026

(54) USER EQUIPMENT (UE)-SPECIFIC RADIO LINK FAILURE PARAMETER SELECTION

(71) Applicant: QUALCOMM Incorporated, San Diego, CA (US)

(72) Inventors: Mickael MONDET, Louannec (FR); Prasada Veera Reddy KADIRI, San Diego, CA (US); Diana MAAMARI, San Diego, CA (US); Gavin Bernard HORN, La Jolla, CA (US); Sitaramanjaneyulu KANAMARLAPUDI, San Diego, CA (US); Ozcan OZTURK, San Diego, CA (US)

(21) Appl. No.: 18/770,471

(22) Filed: Jul. 11, 2024

(51) Int. Cl. H04W 24/10; H04B 17/318; H04W 8/22

(52) U.S. Cl. CPC H04W 24/10; H04B 17/328; H04W 8/22

(57) ABSTRACT

Methods, systems, and devices for wireless communications are described. In some systems, a user equipment (UE) may monitor one or more metrics for a radio link to determine whether to trigger radio link failure. The UE may use an in-sync counter, an out-of-sync counter, and a radio link failure timer to track the radio link quality. A network entity may transmit, to the UE, configuration signaling indicating ranges of values for the in-sync counter, the out-of-sync counter, the radio link failure timer, or any combination thereof. The UE may select values to use for the in-sync counter, the out-of-sync counter, the radio link failure timer, or any combination thereof based on the configured ranges, one or more current radio link measurements, and historic radio link measurements. In some cases, the UE may use an artificial intelligence (AI) model to perform the value selection for radio link failure detection.

### FIELD OF TECHNOLOGY

The following relates to wireless communications, including user equipment (UE)-specific radio link failure parameter selection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A UE may perform radio link measurements to monitor a current quality of a radio link between the UE and a network entity. The UE may use radio link failure parameters to track the radio link quality and trigger radio link failure if the radio link quality is below a threshold for a specific length of time. However, the values configured for these radio link failure parameters may affect the UE's performance. If the network configures the UE with values for these radio link failure parameters, the UE may potentially experience service interruptions, inefficient radio resource usage, or both based on the network configuration.

### SUMMARY

The systems, methods, and devices of this disclosure each have several innovative aspects, no single one of which is solely responsible for the desirable attributes disclosed herein.

A user equipment (UE) for wireless communications is described. The UE may include one or more memories storing processor-executable code and one or more processors coupled with the one or more memories. The one or more processors may individually or collectively be operable to execute the code to cause the UE to receive configuration signaling that indicates a first range of values for an out-of-sync counter, a second range of values for an in-sync counter, a third range of values for a radio link failure timer, or any combination thereof. The one or more processors may individually or collectively be further operable to execute the code to cause the UE to select a first value for the out-of-sync counter, a second value for the in-sync counter, a third value for the radio link failure timer, or any combination thereof based on the configuration signaling, a current radio link measurement at the UE, and a historic radio link measurement at the UE. The one or more processors may individually or collectively be further operable to execute the code to cause the UE to communicate via a radio link based on the first value for the out-of-sync counter, the second value for the in-sync counter, the third value for the radio link failure timer, or any combination thereof.

A method for wireless communications at a UE is described. The method may include receiving configuration signaling that indicates a first range of values for an out-of-sync counter, a second range of values for an in-sync counter, a third range of values for a radio link failure timer, or any combination thereof. The method may further include selecting a first value for the out-of-sync counter, a second value for the in-sync counter, a third value for the radio link failure timer, or any combination thereof based on the configuration signaling, a current radio link measurement at the UE, and a historic radio link measurement at the UE. The method may further include communicating via a radio link based on the first value for the out-of-sync counter, the second value for the in-sync counter, the third value for the radio link failure timer, or any combination thereof.

Another UE for wireless communications is described. The UE may include means for receiving configuration signaling that indicates a first range of values for an out-of-sync counter, a second range of values for an in-sync counter, a third range of values for a radio link failure timer, or any combination thereof. The UE may further include means for selecting a first value for the out-of-sync counter, a second value for the in-sync counter, a third value for the radio link failure timer, or any combination thereof based on the configuration signaling, a current radio link measurement at the UE, and a historic radio link measurement at the UE. The UE may further include means for communicating via a radio link based on the first value for the out-of-sync counter, the second value for the in-sync counter, the third value for the radio link failure timer, or any combination thereof.

A non-transitory computer-readable medium storing code for wireless communications is described. The code may include instructions executable by one or more processors to receive configuration signaling that indicates a first range of values for an out-of-sync counter, a second range of values for an in-sync counter, a third range of values for a radio link failure timer, or any combination thereof. The code may include instructions further executable by the one or more processors to select a first value for the out-of-sync counter, a second value for the in-sync counter, a third value for the radio link failure timer, or any combination thereof based on the configuration signaling, a current radio link measurement at the UE, and a historic radio link measurement at the UE. The code may include instructions further executable by the one or more processors to communicate via a radio link based on the first value for the out-of-sync counter, the second value for the in-sync counter, the third value for the radio link failure timer, or any combination thereof.

Some examples of the method, UEs, and non-transitory computer-readable medium described herein may further include operations, features, means, or instructions for triggering a radio link failure for the radio link based on the first value for the out-of-sync counter, the second value for the in-sync counter, the third value for the radio link failure timer, or any combination thereof.

Some examples of the method, UEs, and non-transitory computer-readable medium described herein may further include operations, features, means, or instructions for incrementing the out-of-sync counter based on a radio link measurement failing to satisfy a first radio link quality threshold and starting the radio link failure timer based on the out-of-sync counter satisfying the first value for the out-of-sync counter.

Some examples of the method, UEs, and non-transitory computer-readable medium described herein may further include operations, features, means, or instructions for incrementing the in-sync counter based on the radio link measurement satisfying a second radio link quality threshold and stopping the radio link failure timer based on the in-sync counter satisfying the second value for the in-sync counter.

In some examples of the method, UEs, and non-transitory computer-readable medium described herein, to trigger the radio link failure, the method, UEs, and non-transitory computer-readable medium may include operations, features, means, or instructions for triggering the radio link failure based on an expiry of the radio link failure timer in accordance with the third value for the radio link failure timer.

Some examples of the method, UEs, and non-transitory computer-readable medium described herein may further include operations, features, means, or instructions for transmitting a report message that indicates the first value for the out-of-sync counter, the second value for the in-sync counter, the third value for the radio link failure timer, or any combination thereof. Some such examples of the method, UEs, and non-transitory computer-readable medium described herein may further include operations, features, means, or instructions for receiving second configuration signaling that configures the UE with a first updated value for the out-of-sync counter, a second updated value for the in-sync counter, a third updated value for the radio link failure timer, or any combination thereof based on the report message.

In some examples of the method, UEs, and non-transitory computer-readable medium described herein, to transmit the report message, the method, UEs, and non-transitory computer-readable medium may include operations, features, means, or instructions for transmitting the report message based on a periodicity, a reporting schedule, a trigger, a prohibit timer, or any combination thereof. In some examples of the method, UEs, and non-transitory computer-readable medium described herein, the report message further indicates one or more performance targets corresponding to the first value for the out-of-sync counter, the second value for the in-sync counter, the third value for the radio link failure timer, or any combination thereof. In some examples of the method, UEs, and non-transitory computer-readable medium described herein, the report message includes a first radio resource control (RRC) message, a first medium access control (MAC) control element (CE), an uplink control information (UCI) message, or any combination thereof, and the second configuration signaling includes a second RRC message, a second MAC-CE, a downlink control information (DCI) message, or any combination thereof.

In some examples of the method, UEs, and non-transitory computer-readable medium described herein, to select the first value for the out-of-sync counter, the second value for the in-sync counter, the third value for the radio link failure timer, or any combination thereof, the method, UEs, and non-transitory computer-readable medium may include operations, features, means, or instructions for inputting, to an artificial intelligence (AI) model, one or more values indicating a set of parameters including at least the current radio link measurement, the historic radio link measurement, and the first range of values for the out-of-sync counter, the second range of values for the in-sync counter, the third range of values for the radio link failure timer, or any combination thereof, where the AI model outputs an indication of the first value for the out-of-sync counter, the second value for the in-sync counter, the third value for the radio link failure timer, or any combination thereof based on the input one or more values.

In some examples of the method, UEs, and non-transitory computer-readable medium described herein, the set of parameters includes a first quantity of times the radio link failure timer is started, a second quantity of times the radio link failure timer is reset, a third quantity of times the radio link failure timer expires, a fourth quantity of times the UE switches to an in-sync mode, a first time to trigger radio link failure, a second time that the UE maintains radio link connectivity with a cell, a fifth quantity of times main cell group failure occurs, a sixth quantity of times secondary cell group failure occurs, a set of reasons for the radio link failure, a block error rate (BLER) metric, a reference signal received power (RSRP) metric, or any combination thereof.

Some examples of the method, UEs, and non-transitory computer-readable medium described herein may further include operations, features, means, or instructions for training the AI model based on one or more performance targets for radio link failure. Some examples of the method, UEs, and non-transitory computer-readable medium described herein may further include operations, features, means, or instructions for collecting data associated with the set of parameters and transmitting a report message that indicates at least a portion of the collected data based on a network configuration, a periodicity, a reporting scheduled, a trigger, a prohibit timer, or any combination thereof.

Some examples of the method, UEs, and non-transitory computer-readable medium described herein may further include operations, features, means, or instructions for receiving third configuration signaling that indicates one or more performance targets for radio link failure, where the selecting the first value for the out-of-sync counter, the second value for the in-sync counter, the third value for the radio link failure timer, or any combination thereof is further based on the one or more performance targets for the radio link failure.

Some examples of the method, UEs, and non-transitory computer-readable medium described herein may further include operations, features, means, or instructions for further selecting an evaluation criterion for a BLER metric, an interval time for discontinuous reception (DRX), a reference signal type for radio link failure determination, a reference signal metric for the radio link failure determination, a radio link failure relaxation criterion, a radio link quality threshold, an additional timer value, an additional counter value, or any combination thereof based on the current radio link measurement and the historic radio link measurement, where the communicating via the radio link is further based on the further selecting.

Some examples of the method, UEs, and non-transitory computer-readable medium described herein may further include operations, features, means, or instructions for receiving fourth configuration signaling that configures the UE to perform flexible selection of the first value for the out-of-sync counter, the second value for the in-sync counter, the third value for the radio link failure timer, or any combination thereof, where the selecting the first value for the out-of-sync counter, the second value for the in-sync counter, the third value for the radio link failure timer, or any combination thereof is further based on the fourth configuration signaling.

Some examples of the method, UEs, and non-transitory computer-readable medium described herein may further include operations, features, means, or instructions for transmitting a report message that indicates a UE capability to perform flexible selection of the first value for the out-of-sync counter, the second value for the in-sync counter, the third value for the radio link failure timer, or any combination thereof, where the selecting the first value for the out-of-sync counter, the second value for the in-sync counter, the third value for the radio link failure timer, or any combination thereof is further based on the UE capability.

In some examples of the method, UEs, and non-transitory computer-readable medium described herein, the first range of values for the out-of-sync counter, the second range of values for the in-sync counter, the third range of values for the radio link failure timer, or any combination thereof includes a first threshold value and a second threshold value defining a range of values, a list of possible values defining the range of values, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support user equipment (UE)-specific radio link failure parameter selection in accordance with one or more aspects of the present disclosure.

FIG. 3 shows an example of a radio link failure timeline that supports UE-specific radio link failure parameter selection in accordance with one or more aspects of the present disclosure.

FIG. 4 shows an example of a machine learning (ML) model represented by an artificial neural network (ANN) that supports UE-specific radio link failure parameter selection in accordance with one or more aspects of the present disclosure.

FIG. 5 shows an example of an ML architecture in a wireless communications system that supports UE-specific radio link failure parameter selection in accordance with one or more aspects of the present disclosure.

FIG. 6 shows an example of a process flow that supports UE-specific radio link failure parameter selection in accordance with one or more aspects of the present disclosure.

FIGS. 7 and 8 show block diagrams of devices that support UE-specific radio link failure parameter selection in accordance with one or more aspects of the present disclosure.

FIG. 9 shows a block diagram of a communications manager that supports UE-specific radio link failure parameter selection in accordance with one or more aspects of the present disclosure.

FIG. 10 shows a diagram of a system including a device that supports UE-specific radio link failure parameter selection in accordance with one or more aspects of the present disclosure.

FIGS. 11 through 13 show flowcharts illustrating methods that support UE-specific radio link failure parameter selection in accordance with one or more aspects of the present disclosure.

### DETAILED DESCRIPTION

Some wireless communications systems may support relatively high-speed, low-latency, and high-reliability wireless connectivity via radio links. Such systems may enable latency-sensitive services, such as immersive extended reality (XR) multimedia (e.g., for augmented reality (AR) glasses, for virtual reality (VR) head-mounted displays), cloud computing (e.g., cloud gaming, cloud AI), or other applications. Maintaining a relatively strong connection via a radio link may be important to satisfy the latency thresholds for such latency-sensitive services. However, radio link failure may negatively affect such latency-sensitive services (e.g., XR applications, AR applications, VR applications) by decreasing communication reliability and increasing communication latencies. Accordingly, improving radio link failure procedures may improve user experience, communication reliability, and communication latency for latency-sensitive services.

A user equipment (UE) may use one or more radio link metrics to trigger radio link failure. For example, the UE may monitor for one or more reference signals associated with a radio link and measure a reference signal received power (RSRP), a reference signal received quality (RSRQ), or other measurements for the radio link using the one or more reference signals. The UE may use such radio link measurements, along with one or more counters and timers, to trigger radio link failure, for example, if a quality of the radio link fails to satisfy a threshold value for a period of time. In some systems, a network entity may semi-statically configure the UE with values (e.g., threshold values) for the counters, timers, or both. However, such a semi-static configuration of these radio link failure parameters may fail to account for the UE's current operating conditions, reducing the effectiveness and efficiency of the radio link failure procedures.

To improve radio link failure procedures, a UE may support dynamic selection of radio link failure parameter values. For example, the UE may autonomously select one or more values for one or more counters, one or more timers, or some combination thereof for radio link monitoring. The UE may use an in-sync counter, an out-of-sync counter, and a radio link failure timer to track the radio link quality. A network entity may transmit, to the UE, configuration signaling that configures the UE to perform flexible selection of the values for one or more of these radio link failure parameters. Additionally, or alternatively, the network entity may configure the UE with ranges of values for the in-sync counter, the out-of-sync counter, the radio link failure timer, or any combination thereof. The UE may select values to use for the in-sync counter, the out-of-sync counter, the radio link failure timer, or any combination thereof based on the configured ranges, one or more current radio link measurements, and one or more historic radio link measurements. In some cases, the UE may use an artificial intelligence (AI) or machine learning (ML) model to perform the value selection. The UE may communicate with the network via a radio link and may monitor the radio link using the selected values for the radio link failure parameters. By using the selected values for radio link monitoring, the UE may maintain a relatively strong connection via a radio link for a greater amount of time, supporting improved communication reliability and latency for applications (e.g., latency-sensitive applications, such as XR, AR, or VR applications).

In some examples, the UE may perform data collection to improve an AI-based value selection procedure. For example, the UE may track key performance indicators (KPIs) based on the radio link failure procedure and may use the KPIs to refine the AI model for value selection. Additionally, or alternatively, the UE may report the collected data to the network, such that the network may perform network-based model training. The UE may train the AI model to improve the value selection, such that the UE may optimize—or otherwise improve—radio link failure timing to balance reducing a processing overhead associated with radio link failure with improving communication reliability and latency associated with communicating via a current radio link.

Aspects of the disclosure are initially described in the context of wireless communications systems. Additional aspects of the disclosure are described with reference to a radio link failure timeline, AI components and procedures, and a process flow. Aspects of the disclosure are further illustrated by and described with reference to apparatus diagrams, system diagrams, and flowcharts that relate to UE-specific radio link failure parameter selection.

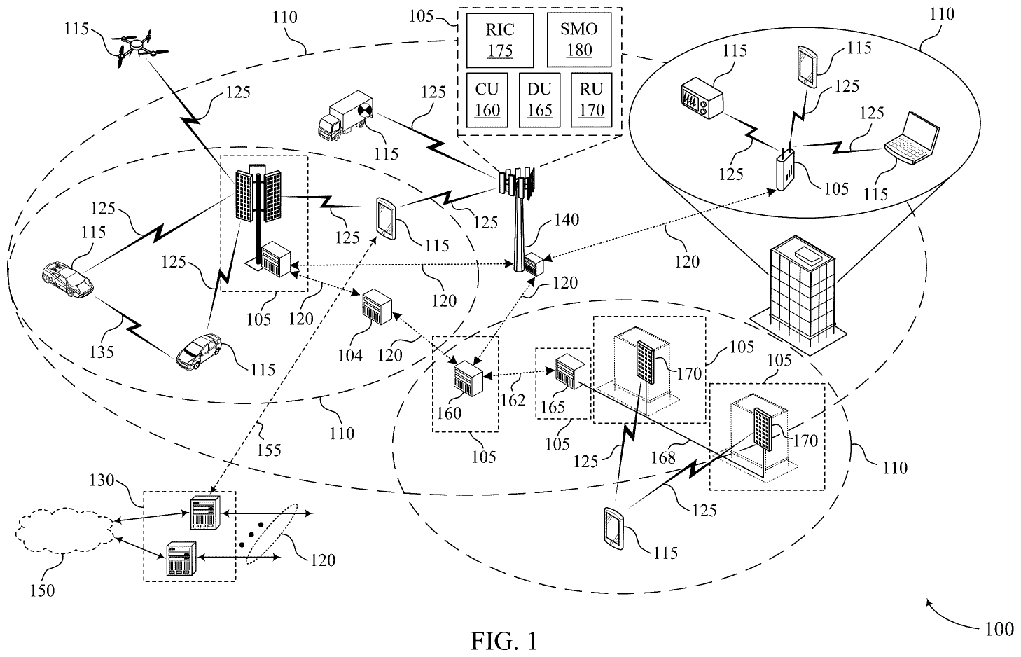

FIG. 1 shows an example of a wireless communications system 100 that supports UE-specific radio link failure parameter selection in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communications systems 100 may support relatively high-speed, low-latency, and high-reliability wireless connectivity via radio links. Such systems may enable latency-sensitive services, such as immersive XR multimedia (e.g., for AR glasses, for VR head-mounted displays), cloud computing (e.g., cloud gaming, cloud AI), or other applications. Such applications may satisfy system thresholds, such as a threshold data rate, a threshold latency for communications, a threshold power consumption, or some combination thereof. For example, the wireless communications system 100 may support 99% of packets for XR traffic being delivered within a packet delay budget (PDB) threshold (e.g., 10 ms) for an application. Radio link failure may negatively affect such latency-sensitive services (e.g., XR applications) by decreasing communication reliability and increasing communication latencies. Accordingly, improving radio link failure procedures may improve user experience, communication reliability, and communication latency for latency-sensitive services.

A UE 115 may monitor a quality of a radio link and may trigger a radio link failure procedure if the quality of the radio link degrades (e.g., below a threshold). For example, the UE 115 may perform radio link monitoring using a reference signal for the radio link. In some cases, the radio link monitoring procedure may be specific to an active BWP, a discontinuous reception (DRX) mode, a non-DRX mode, a dual active protocol stack (DAPS) configuration, or some combination thereof. The UE 115 may receive the reference signal, such as a synchronization signal block (SSB), a channel state information (CSI) reference signal (RS), or a combination thereof. The UE 115 may measure a quality metric based on the received reference signal, such as an RSRP, an RSRQ, a received signal strength indicator (RSSI), a signal-to-noise ratio (SNR), a signal-to-interference plus noise ratio (SINR), or any other quality metric. If the quality metric for the reference signal fails to satisfy a first threshold (e.g., the quality measurement falls below Qₒᵤₜ), the UE 115 may determine the radio link is “out-of-sync.” In contrast, if the quality metric for the reference signal satisfies a second threshold (e.g., the quality measurement exceeds Qᵢₙ), the UE 115 may determine the radio link is “in-sync.” In frames (or other time intervals) where the radio link quality is assessed, the UE 115 may send an indication of whether the quality metric indicates “out-of-sync” or “in-sync” from a lower layer (e.g., the PHY layer) to a higher layer to track the radio link quality.

In some examples, the radio link failure procedure may use one or more counters and one or more timers to track the radio link quality. For example, the radio link failure procedure may involve a first counter, N310; a second counter, N311; and a timer, T310. N310 may be referred to as an “out-of-sync” counter, N311 may be referred to as an “in-sync” counter, and T310 may be referred to as a “radio link failure” timer. If the UE 115 receives an “out-of-sync” indication from a lower layer while the T310 timer is inactive (e.g., stopped), the UE 115 may increment the N310 counter. If the N310 counter reaches a value set for the N310 counter (e.g., a first value for the out-of-sync counter), the UE 115 may start the T310 timer. If the UE 115 receives an “in-sync” indication from a lower layer while the T310 timer is active (e.g., running), the UE 115 may increment the N311 counter. If the N311 counter reaches a value set for the N311 counter (e.g., a second value for the in-sync counter), the UE 115 may stop the T310 timer. Alternatively, if the T310 timer expires (e.g., the T310 timer runs for a duration of time configured by a third value for the radio link failure timer), the UE 115 may trigger radio link failure and initiate a connection re-establishment procedure.

In some cases, the network (e.g., via a network entity 105) may semi-statically configure the values for the counters and timer via radio resource control (RRC) signaling, such as via system information block 1 (SIB1) for a primary cell (PCell) or secondary cell (SCell). Such values may be referred to as radio link failure parameters. The parameter settings may affect the user experience and radio resource allocation for the UE 115. For example, if radio link failure is declared, the UE 115 may fail to communicate data with the network until the connection re-establishment procedure is complete. Additionally, a UE 115 in an out-of-sync state may fail to transmit uplink traffic (but, in some cases, may still receive downlink traffic), impacting the latency for some services. Semi-static setting of the radio link failure parameters by the network may fail to account for the UE's current environment, including current radio link conditions or qualities that the UE is experiencing.

Semi-static configuration of the radio link failure parameters may cause a UE to declare radio link failure at non-optimal times. The “optimal” values for the radio link failure parameters may be based on the current operating conditions of the UE. If the value configured for N310 or T310 is lower than the optimal value, the UE may declare radio link failure relatively early (e.g. even if the UE may have been able to recover the connection). Similarly, if the value configured for N311 is higher than the optimal value, the UE may take longer to recover the radio link connection, increasing the quantity of radio link failures triggered. In such cases, the UE may experience shorter, but relatively more frequent, service interruptions and may experience significant processing overhead associated with radio link failure and connection re-establishment procedures. Alternatively, if the value configured for N310 or T310 is higher than the optimal value, the UE may declare radio link failure relatively late (e.g. where the UE remains operating via a relatively poor radio link for longer). Similarly, if the value configured for N311 is lower than the optimal value, the UE may recover the radio link connection relatively quickly, decreasing the quantity of radio link failures triggered. In such cases, the UE may experience longer, but relatively less frequent, service interruptions and may inefficiently utilize radio resources. Additionally, the UE may communicate via a radio link with relatively poor quality, leading to lower throughput and increased communication latency.

To improve the optimization of the radio link failure parameters, a UE 115 of the wireless communications system 100 may flexibly select one or more values for the radio link failure parameters. For example, the UE 115 may select a value for the first counter, N310, a value for the second counter, N311, a value for the timer, T310, or any combination thereof. The UE 115 may use AI techniques to perform the selection based on current operation conditions of the UE 115. For example, the UE 115 may autonomously select one or more values based on an AI or ML-based knowledge of radio conditions (e.g., current radio link measurements at the UE 115), reference signal measurements (e.g., historic radio link measurements at the UE 115), neighbor cell configurations, or any other metrics. Accordingly, the UE 115 may adjust the values of the radio link failure parameters to optimize (or relatively improve) for the UE's current environment, enabling the UE to reduce inefficiencies and improve communication reliability associated with performing radio link failure procedures.

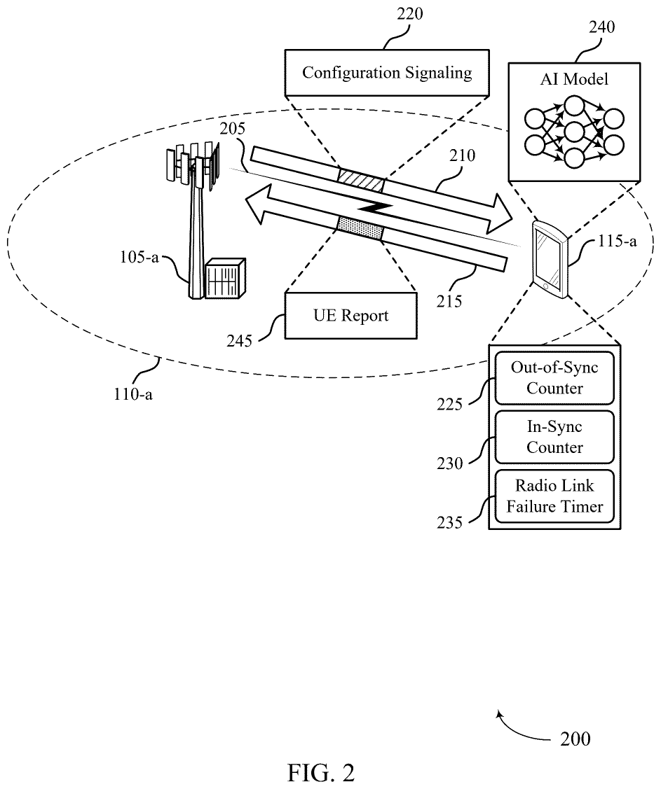

FIG. 2 shows an example of a wireless communications system 200 that supports UE-specific radio link failure parameter selection in accordance with one or more aspects of the present disclosure. The wireless communications system 200 may be an example of a wireless communications system 100 as described with reference to FIG. 1. The wireless communications system 200 may include a UE 115-a and a network entity 105-a, which may be examples of the corresponding devices described with reference to FIG. 1. The network entity 105-a may provide network coverage for a coverage area 110-a. The UE 115-a may use an AI model 240 to dynamically select radio link failure parameters for a radio link 205, such as a first value for an out-of-sync counter 225, a second value for an in-sync counter 230, a third value for a radio link failure timer 235, or any combination thereof.

The UE 115-a may select values (e.g., optimal values, improved values, values satisfying one or more performance targets) for one or more of the radio link failure parameters. The radio link failure parameters may include a first value, N310, for an out-of-sync counter 225; a second value, N311, for an in-sync counter 230; a third value, T310, for a radio link failure timer 235; or any combination thereof. In some examples, the network entity 105-a may configure ranges for the radio link failure parameters to support UE selection. For example, the network entity 105-a may transmit, via a downlink channel 210, configuration signaling 220 to the UE 115-a. The configuration signaling 220 may be an example of radio resource control (RRC) signaling, MAC control element (MAC-CE) signaling, downlink control information (DCI), or any combination thereof.

In some cases, the configuration signaling 220 may configure the UE 115-a to perform flexible selection of one or more radio link failure parameters. For example, in some such cases, the UE 115-a may transmit, via an uplink channel 215, a UE report 245 (e.g., UE capability signaling) indicating that the UE 115-a is capable of flexible selection for the one or more radio link failure parameters. For example, for the values N310, N311, T310, or some combination thereof, the UE 115-a may report to the network a first capability of the UE 115-a to perform a selection (e.g., based on an AI model 240), a second capability of the UE 115-a to collect and report data related to the selection, or both. The network entity 105-a may configure the UE 115-a based on the UE report 245 indicating one or more capabilities of the UE 115-a. For example, the network entity 105-a may transmit the configuration signaling 220 to indicate a network configuration of whether the UE 115-a is to perform flexible selection (e.g., AI-based selection) for N310, N311, T310, or some combination thereof.

The network entity 105-a may configure ranges of values for UE selection. For example, the configuration signaling 220 may indicate a first range of values for N310 (e.g., corresponding to the out-of-sync counter 225), a second range of values for N311 (e.g., corresponding to the in-sync counter 230), a third range of values for T310 (e.g., corresponding to the radio link failure timer 235), or any combination thereof. In some examples, the configuration signaling 220 may indicate a range of values based on boundaries for the selection (e.g., threshold values, such as minimum and maximum values), possible values for the selection (e.g., via a table of selectable values), or both. The UE 115-a may receive the configuration signaling 220 and may select one or more radio link failure parameters based on the configured ranges of values. In some examples, the UE 115-a may select a radio link failure parameter from a corresponding configured range of values using an AI model 240.

In some cases, the UE 115-a may select the one or more radio link failure parameters further based on one or more performance targets. For example, the UE 115-a may use the AI model 240 with the one or more performance targets to determine values for the one or more radio link failure parameters. In some examples, the network entity 105-a may configure a performance target as a sliding measurement window, a target quantity of events within the window, or both. The network entity 105-a may configure, and the UE 115-a may use, any performance target to select a radio link failure parameter.

A first example performance target may indicate a target quantity of times the radio link failure timer 235 is started (e.g., within a window of time). For example, starting the radio link failure timer 235 fewer times than the target may correspond to the UE 115-a starting the radio link failure timer 235 later than optimal. Starting the radio link failure timer 235 later than optimal may cause the UE 115-a to experience a relatively poor connection for relatively too long. To improve the UE's performance, the UE 115-a may adjust one or more radio link failure parameters to search for an improved cell (e.g., an improved radio link) relatively sooner. Alternatively, starting the radio link failure timer 235 more times than the target may correspond to the UE 115-a starting the radio link failure timer 235 earlier than optimal. Starting the radio link failure timer 235 earlier than optimal may cause the UE 115-a to interrupt service (e.g., via a radio link failure) relatively too often. To improve the UE's performance, the UE 115-a may adjust one or more radio link failure parameters to recover a connection relatively more frequently.

A second example performance target may indicate a target delay from the start of the radio link failure timer 235 (e.g., T310) to radio link failure. If the delay from the start of the radio link failure timer 235 to the radio link failure is less than the target delay, the UE 115-a may be interrupting service relatively too often. Alternatively, if the delay from the start of the radio link failure timer 235 to the radio link failure is greater than the target delay, the UE 115-a may be experiencing a relatively poor connection for relatively too long.

A third example performance target may indicate a target quantity of radio link failures (e.g., within a window of time). If the UE 115-a experiences radio link failure more than the target quantity, the UE 115-a may be interrupting service relatively too often. If the UE 115-a experiences radio link failure less than the target quantity, the UE 115-a may be experiencing a relatively poor connection for relatively too long.

A fourth example performance target may indicate a target time to determine a suitable cell (e.g., a cell satisfying one or more performance metrics) after radio link failure. If the UE 115-a takes relatively longer than the target time to determine a new cell or radio link, the UE 115-a may be triggering radio link failure relatively too late (e.g., the UE 115-a may be outside network coverage and may have optimally searched for a suitable cell relatively earlier).

A fifth example performance target may indicate a target quantity of times the UE 115-a selects the same cell after radio link failure occurs. If the UE 115-a selects the same cell relatively more than the target quantity of times, the UE 115-a may be triggering radio link failure relatively too early (e.g., the UE 115-a may be interrupting service relatively too often).

The UE 115-a may select a value from a configured range of values for a radio link failure parameter based on any such performance targets (or any other performance targets). In some examples, the UE 115-a may override a current value (e.g., a network-configured value) for the radio link failure parameter with the UE-selected value. The UE 115-a may inform the network of the UE-selected value (e.g., via a UE report 245). In some other examples, the UE 115-a may maintain using the current value (e.g., the network-configured value) for the radio link failure parameter and may instead transmit an indication of the UE-selected value to the network entity 105-a via a UE report 245. In some cases, the network may configure the UE 115-a, via configuration signaling 220, whether to automatically switch to the UE-selected value or report the UE-selected value. The UE 115-a may handle UE-selected values for N310, N311, and T310 the same or differently (e.g., based on a network configuration or based on a UE preference).

If the UE 115-a is configured to report a UE-selected value, the network entity 105-a may configure how the UE reports the value. In some cases, the UE 115-a may report one or more selected values for radio link failure parameters via RRC signaling, MAC-CE signaling, uplink control information (UCI), or any combination thereof. In some examples, the UE 115-a may periodically—or aperiodically according to a schedule—report the one or more UE-selected values. In some other examples, the UE 115-a may transmit the UE report 245 indicating the one or more UE-selected values based on an event trigger. One example event trigger may be the UE selection of a value different than a currently used value for a radio link failure parameter. In some cases, the UE 115-a may use a prohibit timer to prevent the UE 115-a from transmitting too many UE reports 245 within a time period. For example, if the UE 115-a transmits a UE report 245 indicating one or more selected values for radio link failure parameters, the UE 115-a may activate the prohibit timer and may refrain from transmitting another UE report 245 for the radio link failure parameters while the prohibit timer is active (e.g., running). In some cases, the UE 115-a may report, with a UE-selected value, an indication of one or more performance targets used to determine the UE-selected value.

The network entity 105-a may receive the UE report 245 indicating one or more UE-selected values for the radio link failure parameters. The network entity 105-a may use the UE-selected values as recommendations from the UE 115-a. Based on one or more UE-selected values indicated by the UE report 245, the network entity 105-a may select one or more updated values for the UE 115-a, other UEs 115, or both. The network entity 105-a may transmit configuration signaling 220 configuring the UE 115-a with one or more updated values for the radio link failure parameters (e.g., for the out-of-sync counter 225, the in-sync counter 230, the radio link failure timer 235, or any combination thereof). The updated values may be the same as the UE-selected values indicated (e.g., requested) by the UE 115-a, or the network entity 105-a may determine different values (e.g., based on the UE-selected values).

The network entity 105-a may configure the updated values using an RRC reconfiguration, MAC-CE signaling, DCI, or any combination thereof. In some examples, the network entity 105-a may update a value for a radio link failure parameter at the UE 115-a dynamically. For example, the UE 115-a may store a table (e.g., a lookup table) indicating radio link failure parameter values indexed within the table. In some cases, the network entity 105-a may configure the table using RRC signaling. The network entity 105-a may update a value configured for the UE 115-a by dynamically transmitting a MAC-CE or a DCI message indicating an index, where the index points to a value in the table. The UE 115-a may set the indicated values as the updated value for the corresponding radio link failure parameter (e.g., for N310, N311, or T310). The UE 115-a may confirm successful reception of the MAC-CE or DCI message using a HARQ-acknowledgment (ACK) transmission.

The UE 115-a may track radio link conditions and trigger radio link failure based on the updated values for the out-of-sync counter 225, the in-sync counter 230, the radio link failure timer 235, or any combination thereof. In some examples, the UE 115-a may track the performance of the UE 115-a using the updated values. If the performance degrades (e.g., based on one or more performance targets), the UE 115-a may fall back to using previous values (e.g., previous network-configured values) for one or more of the radio link failure parameters. The fallback procedure may be network-configured or autonomous at the UE 115-a. In some cases, the network entity 105-a may configure the UE 115-a with a time window (e.g., spanning X milliseconds (ms)), a threshold quantity of times, N, that the radio link failure timer 235 is allowed to start during the preceding time window (e.g., a moving window of length X), a prohibit timer, or any combination thereof. If the UE 115-a is using updated values (e.g., UE-selected values) for the out-of-sync counter 225, the in-sync counter 230, the radio link failure timer 235, or any combination thereof, the UE 115-a may determine if the radio link failure timer 235 has been started more than N times during the last X ms. If so, and if the prohibit timer is not running, the UE 115-a may fall back to network-configured values for the out-of-sync counter 225, the in-sync counter 230, the radio link failure timer 235, or the combination thereof and may start the prohibit timer. In some cases, the UE 115-a may switch back to the updated values (e.g., UE-selected values) upon expiration of the prohibit timer.

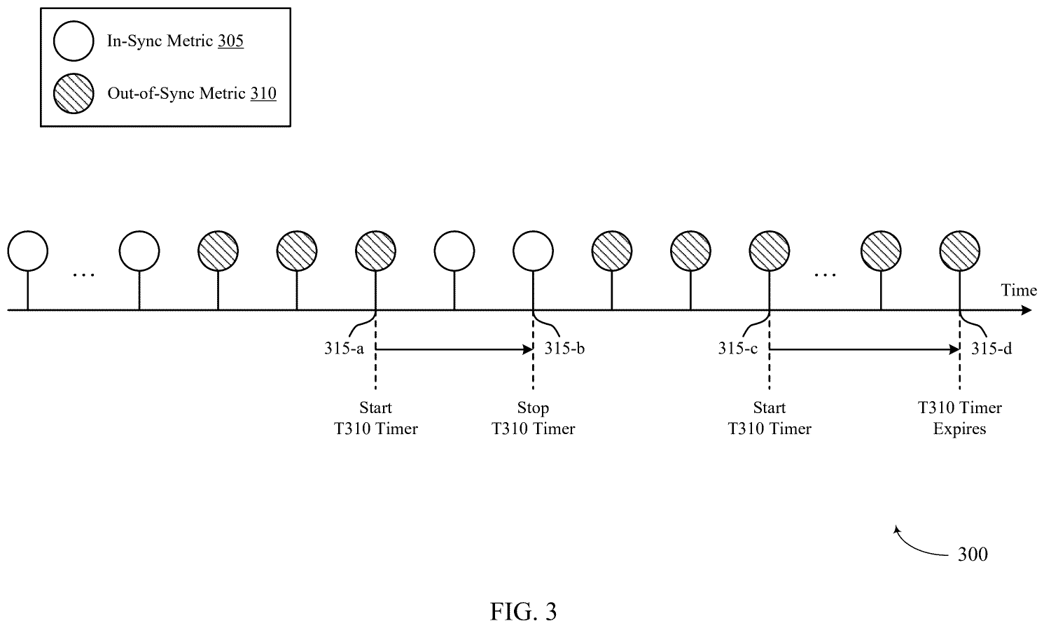

FIG. 3 shows an example of a radio link failure timeline 300 that supports UE-specific radio link failure parameter selection in accordance with one or more aspects of the present disclosure. A UE 115, such as a UE 115 described with reference to FIGS. 1 and 2, may track radio link performance according to the radio link failure timeline 300. For example, the UE 115 may perform radio link measurements and use one or more radio link failure parameters to trigger radio link failure.

The UE 115 may monitor one or more reference signals associated with the radio link. If a quality measurement for a reference signal is below a threshold value, Qₒᵤₜ, the quality measurement may be an out-of-sync metric 310. In some cases, the UE 115 may increment an out-of-sync counter based on the out-of-sync metric 310. Alternatively, if a quality measurement for a reference signal is above a threshold value, Qᵢₙ, the quality measurement may be an in-sync metric 305. In some cases, the UE 115 may increment an in-sync counter based on the in-sync metric 305.

If the quality measurement is below Qₒᵤₜ for consecutive measurements a quantity of times equal to the value set for the out-of-sync counter, the UE 115 may start a radio link failure timer, T310. For example, the UE 115 may select a value of three for the out-of-sync counter. The UE 115 may experience three consecutive out-of-sync metrics 310 at 315-a, such that the out-of-sync counter satisfies the value of three. The UE 115 may trigger starting the T310 timer at 315-a.However, if before the T310 timer expiry, the quality measurement is above Qᵢₙ for consecutive measurements a quantity of times equal to the value set for the in-sync counter, the UE 115 may stop the radio link failure timer, T310 (and reset the timer). For example, the UE 115 may select a value of two for the in-sync counter. The UE 115 may experience, while the T310 timer is active, two consecutive in-sync metrics 305 at 315-b, such that the in-sync counter satisfies the value of two. The UE 115 may trigger stopping the T310 timer at 315-b. The UE 115 may restart the T310 timer at 315-c based on three more consecutive out-of-sync metrics 310. At 315-d, the T310 timer may expire (e.g., without being stopped based on in-sync metrics 305). If the T310 timer expires, the UE 115 may trigger radio link failure for the radio link.

In some cases, the UE 115 may reset a counter based on determining a different type of metric. For example, if the UE 115 increments the out-of-sync counter, but then receives an in-sync metric 305, the UE 115 may reset the out-of-sync counter back to zero. Similarly, if the UE 115 increments the in-sync counter, but then receives an out-of-sync metric 310, the UE 115 may reset the in-sync counter back to zero. In some other cases, the UE 115 may refrain from resetting the counters based on other types of metrics (e.g., such that the UE 115 may increment counters based on non-consecutive metrics).

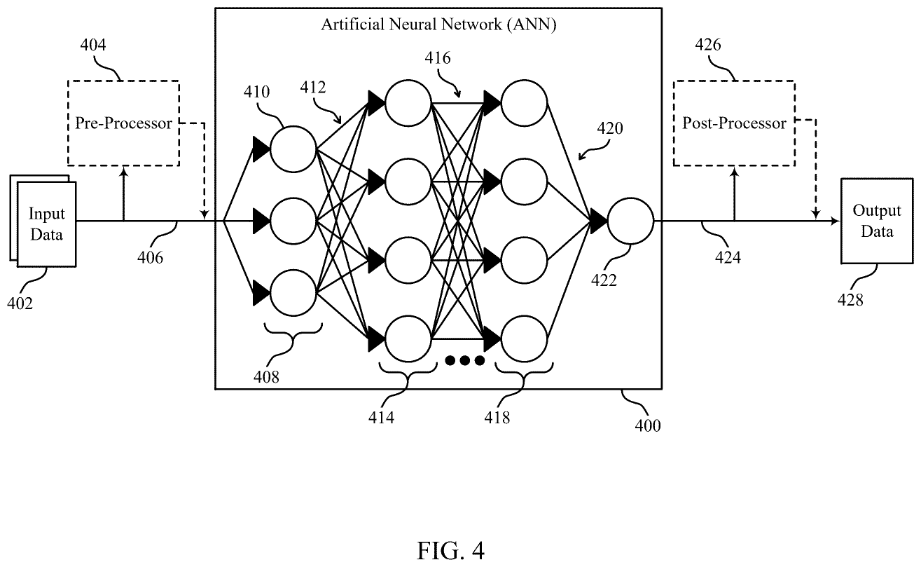

FIG. 4 shows an example of an ML model represented by an artificial neural network (ANN) 400 that supports UE-specific radio link failure parameter selection in accordance with one or more aspects of the present disclosure. A device, such as a UE 115 as described with reference to FIGS. 1 and 2, may use the ANN 400 to select values for radio link failure parameters. The ANN 400 may be trained to optimize the UE 115 performance based on the selected values, such as by selecting values for radio link failure parameters that optimize—or otherwise improve—an amount of time the UE 115 is communicating via a “high quality” link (e.g., a radio link satisfying a quality threshold). The UE 115 may support an AI-native solution for the value selection, in which the AI model is a component of—or is otherwise embedded at—the UE 115. The Al-native solution may involve the AI model natively embedded at the UE 115 (e.g., the ANN 400 with model inputs, model outputs, and constraints), configuration of performance targets and value ranges at the UE 115, UE reporting to build or improve the Al model (e.g., the AI model at the UE 115, or another AI model at a network entity 105), UE reporting to indicate AI behavior to the network, or any combination thereof.

The ANN 400 may receive input data 406 which may include one or more bits of data 402, pre-processed data output from a pre-processor 404 (optional), or some combination thereof. Here, data 402 may include training data, verification data, application-related data, or the like, based, for example, on the stage of deployment of the ANN 400. For example, the data 402 may include radio link quality metrics (e.g., current, historical, or both), such as an RSRP, an RSRQ, an RSSI, an SNR, a SINR, or any other metric measured using a reference signal to indicate the quality of a radio link. Additionally, or alternatively, the data 402 may include radio link failure data, such as data tracking timer or counter usage for the radio link failure parameters. The pre-processor404 may be included within the ANN 400 in some other implementations. The pre-processor 404 may, for example, process all or a portion of the data 402 which may result in some of the data 402 being changed, replaced, deleted, or the like. In some implementations, the pre-processor 404 may add additional data to the data 402. In some implementations, the pre-processor 404 may be an ML model, such as another ANN.

The UE 115 hosting the ANN 400 may perform data collection to train the ANN 400 or to provide data to the network. In some cases, a network entity may configure the UE 115 to perform data collection, reporting, or both associated with selecting values for N310, N311, T310, or any combination thereof. In some examples, the UE 115 may collect data indicating the values selected by the UE 115 (e.g., “optimal” values output by the ANN 400) since a previous data report. Additionally, or alternatively, the UE 115 may collect data indicating a quantity of occurrences of the value for N310 being reached, the value for N311 being reached, T310 expiring, or any combination thereof. In some examples, the UE 115 may use the collected data to train—or otherwise refine—the ANN 400. Additionally, or alternatively, the UE 115 may report the collected data to the network. For example, the network may configure the UE 115 to transmit periodic data reporting, scheduled data reporting, event-triggered data reporting (e.g., if a difference between a newly selected value and a previous value exceeds a configurable threshold), or any other data reporting. In some cases, the network may configure a prohibit timer for the UE 115 to reduce the quantity of reports transmitted by the UE 115, reducing the processing power and signaling overhead associated with the data reporting. A network entity 105 may receive the data reporting and may use the UE-collected data to build, or otherwise train, a network-side AI or ML model.

The ANN 400 may include at least one first layer 408 of artificial neurons 410 to process the input data 406 and provide resulting first layer data via connections or “edges” such as edges 412 to at least a portion of at least one second layer 414. The second layer 414 processes data received via edges 412 and provides second layer output data via edges 416 to at least a portion of at least one third layer 418. The third layer 418 processes data received via edges 416 and provides third layer output data via edges 420 to at least a portion of a final layer 422 including one or more neurons to provide output data 424. All or part of the output data 424 may be further processed in some manner by a (optional) post-processor 426. Thus, in certain examples, the ANN 400 may provide output data 428 that is based on output data 424, post-processed data output from the post-processor 426, or some combination thereof.

The post-processor 426 may be included within the ANN 400 in some other implementations. The post-processor 426 may, for example, process all or a portion of the output data 424 which may result in the output data 428 being different, at least in part, to the output data 424, as result of data being changed, replaced, deleted, or the like. In some examples, the output data 428 may include—or otherwise indicate—a threshold value for an in-sync counter, a threshold value for an out-of-sync counter, a duration value for a radio link failure timer, or some combination thereof. The UE 115 hosting the ANN 400 may select a value to use for the in-sync counter, the out-of-sync counter, the radio link failure timer, or some combination thereof for radio link failure procedures based on the output data 428. In some implementations, the post-processor 426 may be configured to add additional data to the output data 424. In this example, the second layer 414 and third layer 418 represent intermediate or hidden layers that may be arranged in a hierarchical or other like structure. Although not explicitly shown, there may be one or more further intermediate layers between the second layer 414 and the third layer 418. In some implementations, the post-processor 426 may be an ML model, such as another ANN.

The structure and training of artificial neurons 410 in the various layers may be tailored to specific uses of an application. Within a given layer such as the first layer 408, the second layer 414, or the third layer 418 of the ANN 400, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of the ANN 400. The weights and biases of the ANN 400 may be adjusted during a training process or during operation of the ANN 400. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 406. Some non-exhaustive example activation functions include a sigmoid-based activation function, a hyperbolic tangent (tanh)-based activation function, a convolutional activation function, up-sampling, pooling, and a rectified linear unit (ReLU)-based activation function.

Training of an ML model, such as the ANN 400, may be conducted using training data. Training data may include one or more datasets which the ANN 400 may use to identify patterns or relationships. Training data may represent various types of information, including written, visual, audio, environmental context, operational properties, or other types of data. During training, the parameters (such as the weights and biases) of artificial neurons 410 may be changed, such as to minimize or otherwise reduce a loss function or a cost function. A training process may be repeated multiple times to fine-tune the ANN 400 with each iteration.

The ANN 400 or other ML models may be implemented in various types of processing circuits along with memory and applicable instructions therein. For example, general-purpose hardware circuits, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed.

In example aspects, an ML model may be trained prior to, or at some point following, operation of the ML model, such as the ANN 400, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a UE 115 or other device in a wireless communication system, or one or more network entities, or aggregated from multiple sources (such as a UE and a network entity, one or more other UEs, the Internet, or the like). For example, wireless network architectures, such as self-organizing networks (SON) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like.

For example, the UE 115 hosting the ANN 400 may train and improve the ANN 400 (e.g., the AI model, such as an ML model) using specific radio link monitoring KPIs. Such KPIs may include, but are not limited to, a quantity of times the N310 counter indicated to start the T310 timer, a quantity of times the UE 115 failed to satisfy the N310 value of consecutive out-of-sync metrics (e.g., and returned to in-sync mode), a quantity of times the T310 timer is reset due to in-sync measurements satisfying the N311 value, a quantity of times the T310 timer expires and results in radio link failure, or a quantity of times a T311 timer expires, indicating a quantity of times the UE 115 performs a ping-pong behavior between out-of-sync mode, starting T310, in-sync mode, and stopping T310, which may result in relative poor radio coverage. Additionally, or alternatively, the KPIs may include an overall time taken to declare radio link failure to acquire a relatively better cell, a quantity of times consecutive radio link failures occur during transition to a relatively better cell, an average time the UE 115 is able to maintain radio link monitoring aspects on a cell (e.g., indicating coverage holes, overlap zones, mobility aspects for the UE 115 or a network entity 105), radio link failures due to fast fading (e.g., from UE mobility or changing radio conditions) while the UE 115 is performing radio link monitoring relaxation, a quantity of times MCG failure occurs compared to a quantity of times SCG failure occurs (e.g., to improve the model's understanding of coverage cells and capacity cells), BLER-based metrics to improve radio connectivity, BWP-specific radio link monitoring aspects (e.g., to improve the model's understanding of loading or interference in specific BWPs), a quantity of times radio link failure is triggered due to synchronization procedure failures compared to other reasons (e.g., like threshold transmissions at RLC or beam failure recovery (BFR)), a quantity of times the UE 115 exits a relaxed radio link monitoring state due to signal quality variation above a threshold value, a quantity of times the UE 115 exits the relaxed radio link monitoring state due to failing to meet an offset threshold, or any other relevant KPIs.

The UE 115 may use any such KPIs as well as other metrics (e.g., current or historic radio link measurements at the UE 115, data collected by other UEs 115 or the network) to train the ANN 400. Such training may further refine the UE-specific radio link monitoring procedures to improve radio link monitoring. Additionally, or alternatively, the UE 115 may report any of these KPIs, metrics, or model components to the network to support network-based model training. The improved ANN 400 may support optimal (or near-optimal or otherwise improved) configuration of radio link failure procedures based on changing radio conditions, loading conditions, or other changes.

Once the ANN 400 has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, re-training it on the data, or using different optimization techniques.

In some implementations, one or more devices or services may support processes relating to an ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of a wireless network to signal the capabilities for performing specific functions related to the ML model, support for specific ML models, capabilities for gathering, creating, or transmitting training data, or other ML related capabilities. ML models in wireless communications systems may, for example, be employed to support decisions or improve performance relating to wireless resource allocation or selection, wireless channel condition estimation, interference mitigation, beam management, positioning accuracy, energy savings, or modulation or coding schemes. In some implementations, model deployment may occur jointly or separately at various network levels, such as, a UE, a network entity such as a base station, or a disaggregated network entity such as a CU, a DU, or an RU.

The UE's behavior may be adapted based on an AI or ML scheduler. For example, the UE 115 may use the ANN 400 to autonomously select (e.g., determine) values or other aspects of radio link monitoring timers, counters, reference signals, or some combination thereof. The ANN 400 may determine output data 428 indicating a value for N310, a value for N311, a value for T310, a value for T311, a type of reference signal to use for radio link monitoring, a type of measurement to use for radio link monitoring, one or more BLER thresholds, or any combination of these or other UE selections configured for AI-powered flexibility at the UE 115. For example, the ANN 400 may indicate for the UE 115 to use RSRP or RSRQ measurements for assessing the radio link quality, where one type of measurement may be more accurate depending on the UE's current environment. The ANN 400 may optimize such selections to improve radio link failure declaration timing (and, correspondingly, meet service thresholds for throughput and latency) based on configured value ranges or flexibility options, radio conditions, reference signals, neighbor cell configurations, measurement or cell selection criteria, the active BWP, service thresholds, application uses, or any combination of these or other parameters. In some examples, the value selection may be further based on the UE's active band (e.g., sub-6 or millimeter wave (mmW)), cell planning (e.g., coverage, capacity, or overlay), type of connectivity (terrestrial or non-terrestrial), cell group type, scheduling pattern (e.g., indicating loading), or any combination thereof. In some cases, the ANN 400 may enable the UE 115 to adapt an offset based on relaxed radio link monitoring criteria, UE mobility, network entity mobility, radio profile variations (e.g., due to fast fading), or any combination thereof.

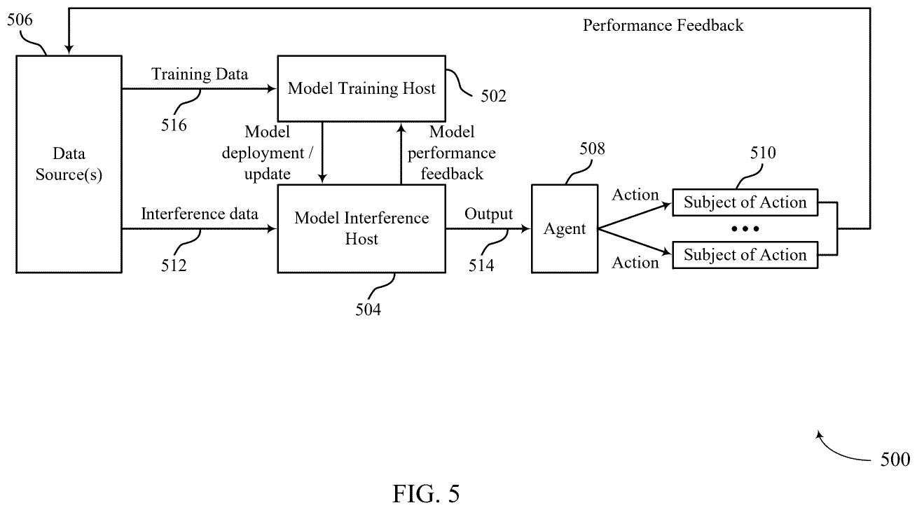

FIG. 5 shows an example of an ML architecture 500 in a wireless communications system that supports UE-specific radio link failure parameter selection in accordance with one or more aspects of the present disclosure. In some examples, a UE, such as a UE 115 as described with reference to FIGS. 1 and 2, may support the ML architecture 500. For example, the UE 115 may store values defining an AI model to use for radio link parameter value selection.

As illustrated, the ML architecture 500 includes multiple logical entities, such as a model training host 502, a model inference host 504, data source(s) 506, and an agent 508. The model inference host 504 is configured to run an ML model based on inference data 512 provided by data source(s) 506. The model inference host 504 may produce output 514, which may include a prediction or inference, such as a discrete or continuous value based on inference data 512, which may then be provided as input to the agent 508.

The agent 508 may represent an element or an entity of a wireless communications system including, for example, a RAN, a wireless local area network, a D2D communications system, or another network. As an example, the agent 508 may be a UE, such as a UE 115 as described with reference to FIGS. 1 and 2. Additionally, the agent 508 also may be a type of agent that depends on the type of tasks performed by the model inference host 504, the type of inference data 512 provided to the model inference host 504, or the type of output 514 produced by the model inference host 504.

The agent 508 may perform one or more actions associated with receiving output 514 from the model inference host 504. For example, the output 514 from the model inference host 504 may indicate one or more values for radio link failure parameters, and the agent 508 may determine whether to change or modify a current radio link parameter value based on the output 514. The agent 508 may indicate the one or more actions performed to at least one subject of an action 510. For example, the agent 508 may transmit a report (e.g., to a network entity 105) indicating the one or more new radio link parameter values. In some cases, the agent 508 and the subject of the action 510 may be the same entity. In some cases, the model training host 502 may receive training data 516 (e.g., from data source(s) 506 or otherwise determined by a device, such as a UE 115) to use for further model training or refinement.

In some aspects, an ML model may be deployed at or on a UE (such as UE 115) for UE-specific radio link failure parameter selection. More specifically, a model inference host, such as the model inference host 504, may be deployed at or on the UE 115 (e.g., the agent 508).

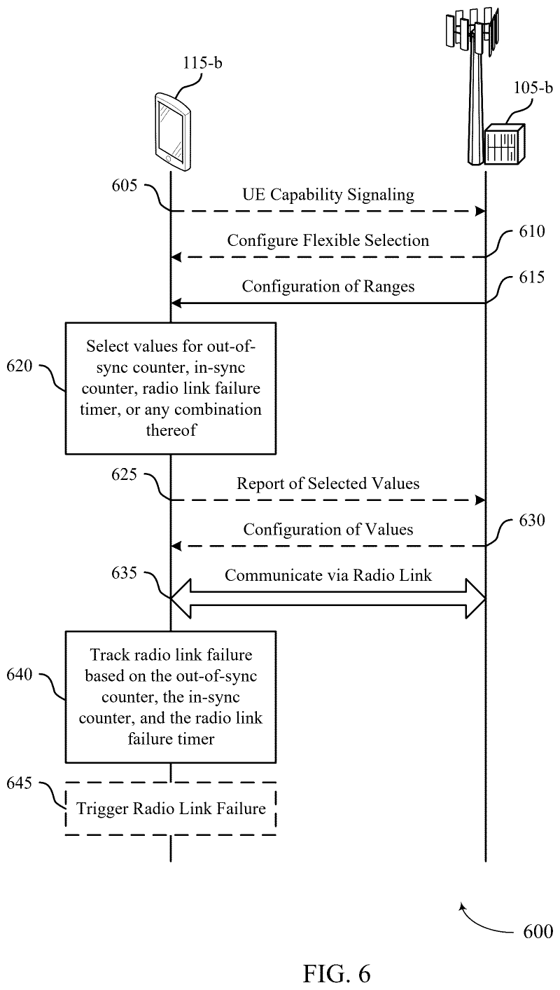

FIG. 6 shows an example of a process flow 600 that supports UE-specific radio link failure parameter selection in accordance with one or more aspects of the present disclosure. The process flow 600 may be performed by aspects of the wireless communications system 100 or the wireless communications system 200, as described herein with reference to FIGS. 1 and 2. For example, a UE 115-b and a network entity 105-b, which may be respective examples of a UE 115 and a network entity 105 described herein, may perform aspects of the process flow 600. In the following description of the process flow 600, operations performed by the UE 115-b and the network entity 105-b may be performed in a different order than is shown. Some operations may be omitted from the process flow 600, and other operations may be added to the process flow 600. Further, although some operations or signaling may be shown to occur at different times for discussion purposes, these operations may occur at the same time. Additionally, or alternatively, other wireless devices may perform aspects of the process flow 600.

In some examples, at 605, the UE 115-b may transmit UE capability signaling to the network entity 105-b. For example, the UE 115-b may transmit a report message that indicates a capability of the UE 115-b to perform flexible selection of one or more radio link failure parameters. The UE capability signaling may indicate that the UE 115-b can perform flexible selection of a first value for an out-of-sync counter, a second value for an in-sync counter, a third value for a radio link failure timer, or any combination thereof. The network entity 105-b may receive the report message that indicates the capability of the UE 115-b.

In some examples, at 610, the network entity 105-b may transmit, to the UE 115-b, configuration signaling that configures flexible selection of one or more radio link failure parameters. In some cases, the network entity 105-b may transmit the configuration signaling based on the UE capability signaling received at 605. The configuration signaling may configure the UE 115-b to perform flexible selection of the first value for the out-of-sync counter, the second value for the in-sync counter, the third value for the radio link failure timer, or any combination thereof. Additionally, or alternatively, the configuration signaling may configure one or more parameters for how the UE 115-b performs the flexible selection. For example, the configuration signaling may configure whether the UE 115-b overrides a current value with a selected value for a radio link failure parameter, whether the UE 115-b reports the selected value to the network, how the UE 115-b reports the selected value, or any combination thereof.

In some cases, the configuration signaling may be an example of an RRC configuration. The RRC configuration may include one or more first RRC information elements (e.g., selectT310/N310/N311). For example, the RRC configuration may include one RRC information element set to {true} or {false} to configure flexible selection of the out-of-sync counter, the in-sync counter, and the radio link failure timer, or the RRC configuration may include a first RRC information element (e.g., selectT310), a second RRC information element (e.g., selectN310), a third RRC information element (e.g., selectN311), or some combination thereof each set to {true} or {false} to independently configure flexible selection of the out-of-sync counter, the in-sync counter, and the radio link failure timer. Similarly, the RRC configuration may include one or more RRC information elements (e.g., override BySelectedT310/N310/N311) set to {true} or {false} to control whether the UE 115-b overrides current values for the out-of-sync counter, the in-sync counter, the radio link failure timer, or a combination thereof with UE-selected values. In some examples, the RRC configuration may include one or more RRC information elements (e.g., selectedT310/N310/N311Report) set to {none}, {periodic}, or {event-triggered} to control if the UE 115-b reports a selected value. If the UE reporting is periodic, the RRC configuration may include one or more RRC information elements (e.g., selectedT310/N310/N311ReportingPeriod) set to an integer value indicating the period for the UE reporting. If the UE reporting is event-triggered, the RRC configuration may include one or more RRC information elements (e.g., selectedT310/N310/N311ProhibitTimer) set to an integer value indicating the length for a prohibit timer prohibiting repeated reporting.

At 615, the network entity 105-b may transmit, to the UE 115-b, configuration signaling that indicates one or more ranges of values for one or more radio link failure parameters. In some examples, the configuration signaling transmitted at 610 and the configuration signaling transmitted at 615 may be the same or similar configuration signaling. The configuration signaling may indicate a first range of values for the out-of-sync counter, a second range of values for the in-sync counter, a third range of values for the radio link failure timer, or any combination thereof. In some cases, the configuration signaling may indicate a range of values using a first threshold value (e.g., a minimum value) and a second threshold value (e.g., a maximum value) defining the range. For example, the configuration signaling may be an example of RRC signaling including one or more RRC information elements (e.g., minSelectedT310/N310/N311) set to a value defining a first threshold value and one or more RRC information elements (e.g., maxSelectedT310/N310/N311) set to a value defining a second threshold value. In some other cases, the configuration signaling may indicate a range of values using a list of values defining the values supporting UE selection. For example, the configuration signaling may be an example of RRC signaling including one or more RRC information elements (e.g., SelectableListT310/N310/N311) set to a list of values defining the range of supported values for UE selection. The UE 115-b may receive the configuration of ranges and may use the configuration of ranges for flexible value selection.

Additionally, or alternatively, the configuration signaling may configure other flexible parameters for the UE 115-b. In some cases, the configuration signaling may indicate a flexible range of timer values for a T311 timer, which may be associated with link reestablishment after radio link failure. In some cases, the configuration signaling may indicate a flexible range of evaluation criteria for a percent (%) block error rate (BLER) case based on configuring values (or using default values, such as 10% and 2% BLER) for an out-of-sync quality threshold, Qₒᵤₜ, and an in-sync quality threshold, Qᵢₙ. In some cases, the configuration signaling may indicate a flexible interval time T_{indication_interval} based on radio conditions for DRX or non-DRX (e.g., based on DRX cycle length). In some cases, the configuration signaling may indicate flexibility for the UE 115-b to select between types of reference signals (e.g., using SSB, CSI-RS, or BLER metrics) for radio link measurements if different types of reference signals are configured. In some cases, the configuration signaling may indicate flexibility for the UE 115-b to select between different measurement types (e.g., between RSRP, RSRQ, or other metrics) for the radio link monitoring evaluation criteria. In some cases, the configuration signaling may indicate flexibility for the UE 115-b for radio link monitoring relaxation based on a relaxation criterion. For example, the UE 115-b may trigger relaxation of one or more radio link monitoring parameters or procedures based on a parameter satisfying a relaxation criterion (e.g., a low MobilityEvaluationConnected or a goodServingCellEvaluationRLM parameter satisfying a low mobility criterion or a good serving cell criterion, respectively). As an example, the low mobility criterion may indicate for the UE 115-b to relax radio link monitoring if the UE 115-b is relatively low-mobility (e.g., moving below a threshold speed or relatively immobile). Additionally, or alternatively, the good serving cell criterion may indicate for the UE 115-b to relax radio link monitoring if the UE 115-b is connected to a cell via a relatively strong radio link connection (e.g., above a threshold quality or strength metric). In some cases, the configuration signaling may indicate to relax a RedCap-specific Qᵢₙ value, a RedCap-specific Qₒᵤₜ value, or both based on a mode of operation for the UE 115-b. In some cases, the configuration signaling may indicate flexibility for the UE 115-b for satellite network-specific synchronization procedure-related counters based on coverage information for the UE 115-b, satellite positioning information (e.g., longitude, latitude, satellite type), or both. The configuration signaling may configure the UE 115-b with any combination of these parameters or flexible procedures.

At 620, the UE 115-b may select one or more values for the one or more radio link parameters based on the configured ranges. For example, the UE 115-b may select a first value for the out-of-sync counter from the first range of values, a second value for the in-sync counter from the second range of values, a third value for the radio link failure timer from the third range of values, or any combination thereof. In some examples, the UE 115-b may select the values using an AI model. For example, the UE 115-b may have AI-native control of the radio link parameters. The UE 115-b may utilize AI (e.g., ML) techniques to determine values (e.g., optimal values) for one or more counters, one or more timers, or both for radio link failure tracking. As an example, the UE 115-b may input, to the AI model, a configured range for a radio link failure parameter (e.g., the out-of-sync counter, the in-sync counter, or the radio link failure timer) and one or more radio link metrics (e.g., current or historic radio link measurements, such as RSRP, RSRQ, RSSI, SNR, SINR, or other metric values). In response to the input, the AI model may output an estimated optimal value (e.g., a “selected” value) for the corresponding radio link failure parameter (e.g., the out-of-sync counter, the in-sync counter, or the radio link failure timer) for the UE 115-b to use.

In some examples, at 625, the UE 115-b may transmit a report message to the network entity 105-b that indicates the one or more selected values. For example, the UE 115-b may report the selected values based on a network configuration. In some such examples, at 630, the network entity 105-b may respond with a configuration of updated values for the UE 115-b. For example, the network entity 105-b may select a first updated value for the out-of-sync counter, a second updated value for the in-sync counter, a third updated value for the radio link failure timer, or any combination thereof based on the values reported by the UE 115-b. The network entity 105-b may transmit configuration signaling indicating the one or more updated values to the UE 115-b.

The UE 115-b may set the values for the radio link parameters based on the UE selection or the updated network configuration. For example, the UE 115-b may override current values for the radio link parameters with the selected values or the updated values received from the network entity 105-b. At 635, the UE 115-b and the network entity 105-b may communicate via the radio link using the new values for the radio link parameters. For example, the UE 115-b may communicate via the radio link based on the first value for the out-of-sync counter, the second value for the in-sync counter, the third value for the radio link failure timer, or some combination thereof.

At 640, the UE 115-b may track radio link failure based on the out-of-sync counter, the in-sync counter, and the radio link failure timer. For example, the UE 115-b may monitor the radio link and determine whether a measurement for the radio link indicates that the radio link is in-sync or out-of-sync. The UE 115-b may track consecutive in-sync measurements using the in-sync counter and may track consecutive out-of-sync measurements using the out-of-sync counter. If the out-of-sync counter satisfies the first value set for the out-of-sync counter, the UE 115-b may trigger activation of the radio link failure timer. If the in-sync counter satisfies the second value set for the in-sync counter, the UE 115-b may trigger stopping the radio link failure timer. If the radio link failure timer is not stopped and expires (e.g., runs for a duration corresponding to the third value for the radio link failure timer), at 645, the UE 115-b may trigger radio link failure for the radio link. If the radio link failure is triggered for a main cell group (MCG), the UE 115-b may perform RRC connection re-establishment. If the radio link failure is triggered for a secondary cell group (SCG), the UE 115-b may suspend the SCG and transmit a notification of the radio link failure to the network entity 105-b.

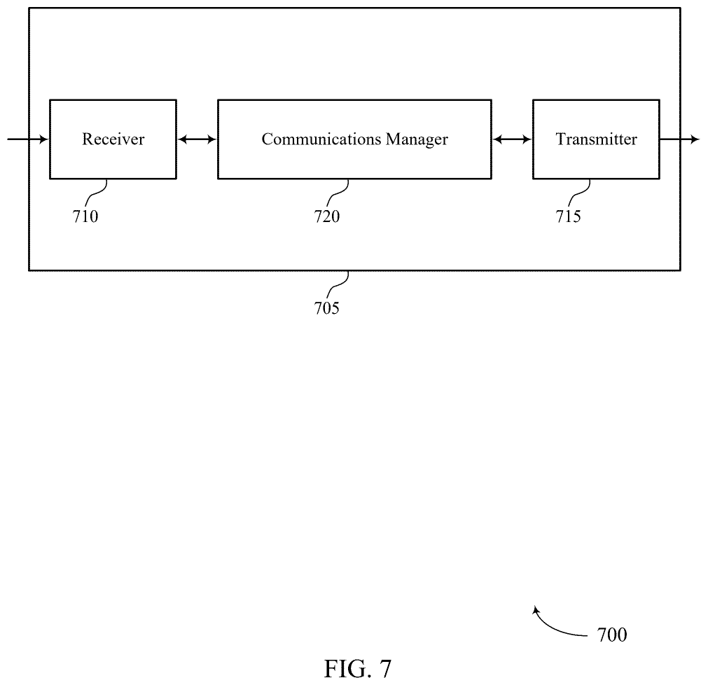

FIG. 7 shows a block diagram 700 of a device 705 that supports UE-specific radio link failure parameter selection in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to UE-specific radio link failure parameter selection). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to UE-specific radio link failure parameter selection). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of UE-specific radio link failure parameter selection as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving configuration signaling that indicates a first range of values for an out-of-sync counter, a second range of values for an in-sync counter, a third range of values for a radio link failure timer, or any combination thereof. The communications manager 720 is capable of, configured to, or operable to support a means for selecting a first value for the out-of-sync counter, a second value for the in-sync counter, a third value for the radio link failure timer, or any combination thereof based on the configuration signaling, a current radio link measurement at the UE, and a historic radio link measurement at the UE. The communications manager 720 is capable of, configured to, or operable to support a means for communicating via a radio link based on the first value for the out-of-sync counter, the second value for the in-sync counter, the third value for the radio link failure timer, or any combination thereof.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for a reduced processing overhead and more efficient utilization of communication resources. For example, by enabling the device 705 to select values for the out-of-sync counter, the in-sync counter, the radio link failure timer, or some combination thereof, the device 705 may improve the radio link failure procedures. The selected values may support the device 705 triggering radio link failure at optimal (or otherwise improved) times. Accordingly, the device 705 may reduce the processing overhead by reducing a quantity of unnecessary radio link failure procedures. Additionally, or alternatively, the device 705 may improve resource utilization by reducing the time spent using unreliable radio links.

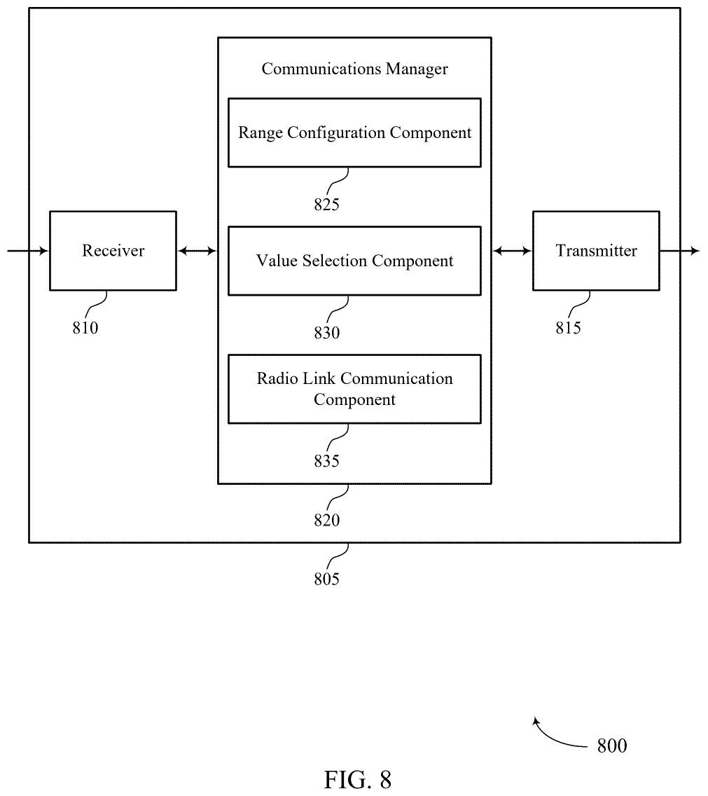

FIG. 8 shows a block diagram 800 of a device 805 that supports UE-specific radio link failure parameter selection in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to UE-specific radio link failure parameter selection). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to UE-specific radio link failure parameter selection). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of UE-specific radio link failure parameter selection as described herein. For example, the communications manager 820 may include a range configuration component 825, a value selection component 830, a radio link communication component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The range configuration component 825 is capable of, configured to, or operable to support a means for receiving configuration signaling that indicates a first range of values for an out-of-sync counter, a second range of values for an in-sync counter, a third range of values for a radio link failure timer, or any combination thereof. The value selection component 830 is capable of, configured to, or operable to support a means for selecting a first value for the out-of-sync counter, a second value for the in-sync counter, a third value for the radio link failure timer, or any combination thereof based on the configuration signaling, a current radio link measurement at the UE, and a historic radio link measurement at the UE. The radio link communication component 835 is capable of, configured to, or operable to support a means for communicating via a radio link based on the first value for the out-of-sync counter, the second value for the in-sync counter, the third value for the radio link failure timer, or any combination thereof.

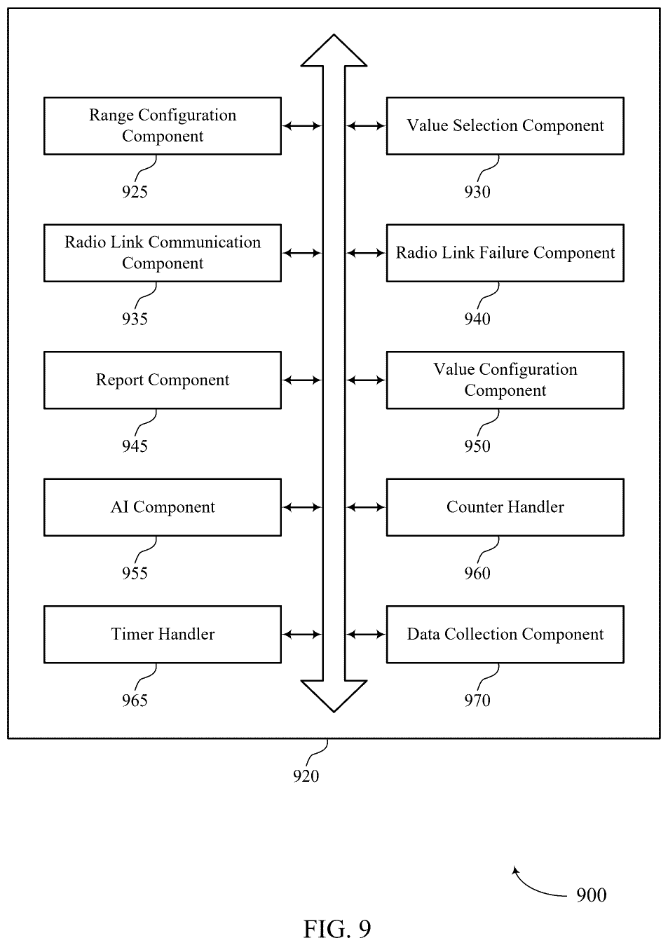

FIG. 9 shows a block diagram 900 of a communications manager 920 that supports UE-specific radio link failure parameter selection in accordance with one or more aspects of the present disclosure. The communications manager 920 may be an example of aspects of a communications manager 720, a communications manager 820, or both, as described herein. The communications manager 920, or various components thereof, may be an example of means for performing various aspects of UE-specific radio link failure parameter selection as described herein. For example, the communications manager 920 may include a range configuration component 925, a value selection component 930, a radio link communication component 935, a radio link failure component 940, a report component 945, a value configuration component 950, an Al component 955, a counter handler 960, a timer handler 965, a data collection component 970, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The range configuration component 925 is capable of, configured to, or operable to support a means for receiving configuration signaling that indicates a first range of values for an out-of-sync counter, a second range of values for an in-sync counter, a third range of values for a radio link failure timer, or any combination thereof. The value selection component 930 is capable of, configured to, or operable to support a means for selecting a first value for the out-of-sync counter, a second value for the in-sync counter, a third value for the radio link failure timer, or any combination thereof based on the configuration signaling, a current radio link measurement at the UE, and a historic radio link measurement at the UE. The radio link communication component 935 is capable of, configured to, or operable to support a means for communicating via a radio link based on the first value for the out-of-sync counter, the second value for the in-sync counter, the third value for the radio link failure timer, or any combination thereof.

In some examples, the radio link failure component 940 is capable of, configured to, or operable to support a means for triggering a radio link failure for the radio link based on the first value for the out-of-sync counter, the second value for the in-sync counter, the third value for the radio link failure timer, or any combination thereof.

In some examples, the counter handler 960 is capable of, configured to, or operable to support a means for incrementing the out-of-sync counter based on a radio link measurement failing to satisfy a first radio link quality threshold. In some examples, the timer handler 965 is capable of, configured to, or operable to support a means for starting the radio link failure timer based on the out-of-sync counter satisfying the first value for the out-of-sync counter.

In some examples, the counter handler 960 is capable of, configured to, or operable to support a means for incrementing the in-sync counter based on the radio link measurement satisfying a second radio link quality threshold. In some examples, the timer handler 965 is capable of, configured to, or operable to support a means for stopping the radio link failure timer based on the in-sync counter satisfying the second value for the in-sync counter.

In some examples, to support triggering the radio link failure, the timer handler 965 is capable of, configured to, or operable to support a means for triggering the radio link failure based on an expiry of the radio link failure timer in accordance with the third value for the radio link failure timer.

In some examples, the report component 945 is capable of, configured to, or operable to support a means for transmitting a report message that indicates the first value for the out-of-sync counter, the second value for the in-sync counter, the third value for the radio link failure timer, or any combination thereof. In some examples, the value configuration component 950 is capable of, configured to, or operable to support a means for receiving second configuration signaling that configures the UE with a first updated value for the out-of-sync counter, a second updated value for the in-sync counter, a third updated value for the radio link failure timer, or any combination thereof based on the report message.

In some examples, to support transmitting the report message, the report component 945 is capable of, configured to, or operable to support a means for transmitting the report message based on a periodicity, a reporting schedule, a trigger, a prohibit timer, or any combination thereof. In some examples, the report message further indicates one or more performance targets corresponding to the first value for the out-of-sync counter, the second value for the in-sync counter, the third value for the radio link failure timer, or any combination thereof. In some examples, the report message includes a first RRC message, a first MAC-CE, a UCI message, or any combination thereof. In some examples, the second configuration signaling includes a second RRC message, a second MAC-CE, a DCI message, or any combination thereof.

In some examples, to support selecting the first value for the out-of-sync counter, the second value for the in-sync counter, the third value for the radio link failure timer, or any combination thereof, the AI component 955 is capable of, configured to, or operable to support a means for inputting, to an AI model, one or more values indicating a set of parameters including at least the current radio link measurement, the historic radio link measurement, and the first range of values for the out-of-sync counter, the second range of values for the in-sync counter, the third range of values for the radio link failure timer, or any combination thereof, where the AI model outputs an indication of the first value for the out-of-sync counter, the second value for the in-sync counter, the third value for the radio link failure timer, or any combination thereof based on the input one or more values. In some examples, the set of parameters includes a first quantity of times the radio link failure timer is started, a second quantity of times the radio link failure timer is reset, a third quantity of times the radio link failure timer expires, a fourth quantity of times the UE switches to an in-sync mode, a first time to trigger radio link failure, a second time that the UE maintains radio link connectivity with a cell, a fifth quantity of times MCG failure occurs, a sixth quantity of times SCG failure occurs, a set of reasons for the radio link failure, a BLER metric, an RSRP metric, or any combination thereof.

In some examples, the AI component 955 is capable of, configured to, or operable to support a means for training the AI model based on one or more performance targets for radio link failure. In some examples, the data collection component 970 is capable of, configured to, or operable to support a means for collecting data associated with the set of parameters. In some examples, the data collection component 970 is capable of, configured to, or operable to support a means for transmitting a report message that indicates at least a portion of the collected data based on a network configuration, a periodicity, a reporting scheduled, a trigger, a prohibit timer, or any combination thereof.

In some examples, the value selection component 930 is capable of, configured to, or operable to support a means for receiving third configuration signaling that indicates one or more performance targets for radio link failure, where the selecting the first value for the out-of-sync counter, the second value for the in-sync counter, the third value for the radio link failure timer, or any combination thereof is further based on the one or more performance targets for the radio link failure.

In some examples, the radio link communication component 935 is capable of, configured to, or operable to support a means for further selecting an evaluation criterion for a BLER metric, an interval time for DRX, a reference signal type for radio link failure determination, a reference signal metric for the radio link failure determination, a radio link failure relaxation criterion, a radio link quality threshold, an additional timer value, an additional counter value, or any combination thereof based on the current radio link measurement and the historic radio link measurement, where the communicating via the radio link is further based on the further selecting.

In some examples, the value selection component 930 is capable of, configured to, or operable to support a means for receiving fourth configuration signaling that configures the UE to perform flexible selection of the first value for the out-of-sync counter, the second value for the in-sync counter, the third value for the radio link failure timer, or any combination thereof, where the selecting the first value for the out-of-sync counter, the second value for the in-sync counter, the third value for the radio link failure timer, or any combination thereof is further based on the fourth configuration signaling.

In some examples, the report component 945 is capable of, configured to, or operable to support a means for transmitting a report message that indicates a UE capability to perform flexible selection of the first value for the out-of-sync counter, the second value for the in-sync counter, the third value for the radio link failure timer, or any combination thereof, where the selecting the first value for the out-of-sync counter, the second value for the in-sync counter, the third value for the radio link failure timer, or any combination thereof is further based on the UE capability.

In some examples, the first range of values for the out-of-sync counter, the second range of values for the in-sync counter, the third range of values for the radio link failure timer, or any combination thereof includes a first threshold value and a second threshold value defining a range of values, a list of possible values defining the range of values, or both.

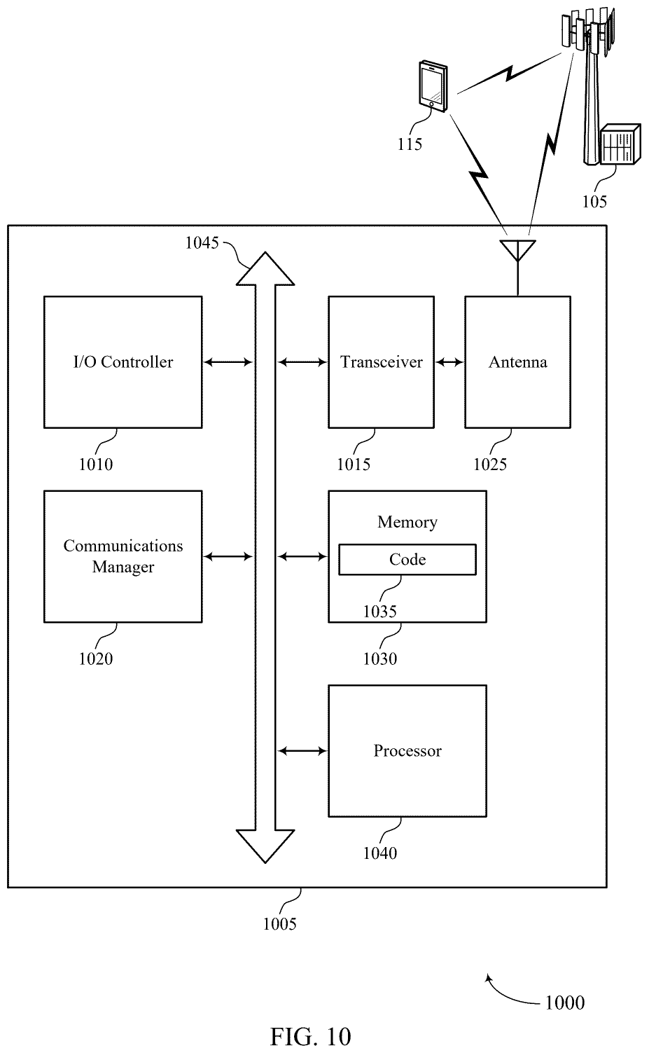

FIG. 10 shows a diagram of a system 1000 including a device 1005 that supports UE-specific radio link failure parameter selection in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®,UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting UE-specific radio link failure parameter selection). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving configuration signaling that indicates a first range of values for an out-of-sync counter, a second range of values for an in-sync counter, a third range of values for a radio link failure timer, or any combination thereof. The communications manager 1020 is capable of, configured to, or operable to support a means for selecting a first value for the out-of-sync counter, a second value for the in-sync counter, a third value for the radio link failure timer, or any combination thereof based on the configuration signaling, a current radio link measurement at the UE, and a historic radio link measurement at the UE. The communications manager 1020 is capable of, configured to, or operable to support a means for communicating via a radio link based on the first value for the out-of-sync counter, the second value for the in-sync counter, the third value for the radio link failure timer, or any combination thereof.

By including or configuring the communications manager 1020 in accordance with examples as described herein, the device 1005 may support techniques for improved communication reliability, reduced latency, improved user experience relating to reduced processing, reduced power consumption, more efficient utilization of communication resources, or any combination thereof.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of UE-specific radio link failure parameter selection as described herein, or the at least one processor 1040 and the at least one memory 1030 may be otherwise configured to, individually or collectively, perform or support such operations.

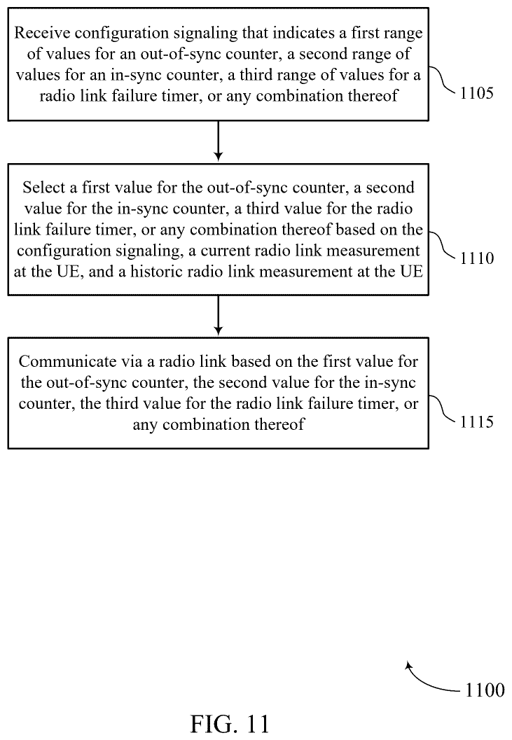

FIG. 11 shows a flowchart illustrating a method 1100 that supports UE-specific radio link failure parameter selection in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving configuration signaling that indicates a first range of values for an out-of-sync counter, a second range of values for an in-sync counter, a third range of values for a radio link failure timer, or any combination thereof. The operations of 1105 may be performed in accordance with examples as disclosed herein, such as the reception of the configuration signaling 220 as described with reference to FIG. 2 or the reception of the configuration signaling at 610 or at 615 as described with reference to FIG. 6. The configuration signaling may include information similar to that described with respect to FIGS. 2 and 6. In some examples, aspects of the operations of 1105 may be performed by a range configuration component 925 as described with reference to FIG. 9.

At 1110, the method may include selecting a first value for the out-of-sync counter, a second value for the in-sync counter, a third value for the radio link failure timer, or any combination thereof based on the configuration signaling, a current radio link measurement at the UE, and/or a historic radio link measurement at the UE. The operations of 1110 may be performed in accordance with examples as disclosed herein, such as the value selection by the UE 115-a as described with reference to FIG. 2, the value selection using an ANN 400 as described with reference to FIG. 4, or the value selection at 620 as described with reference to FIG. 6. The value selection may be based on any combination of parameters described herein with respect to FIGS. 2, 4, and 6. In some examples, aspects of the operations of 1110 may be performed by a value selection component 930 as described with reference to FIG. 9.

At 1115, the method may include communicating via a radio link based on the first value for the out-of-sync counter, the second value for the in-sync counter, the third value for the radio link failure timer, or any combination thereof. The operations of 1115 may be performed in accordance with examples as disclosed herein, such as the radio link monitoring procedures described with reference to FIG. 2 or the communication at 635 as described with reference to FIG. 6. In some examples, aspects of the operations of 1115 may be performed by a radio link communication component 935 as described with reference to FIG. 9.

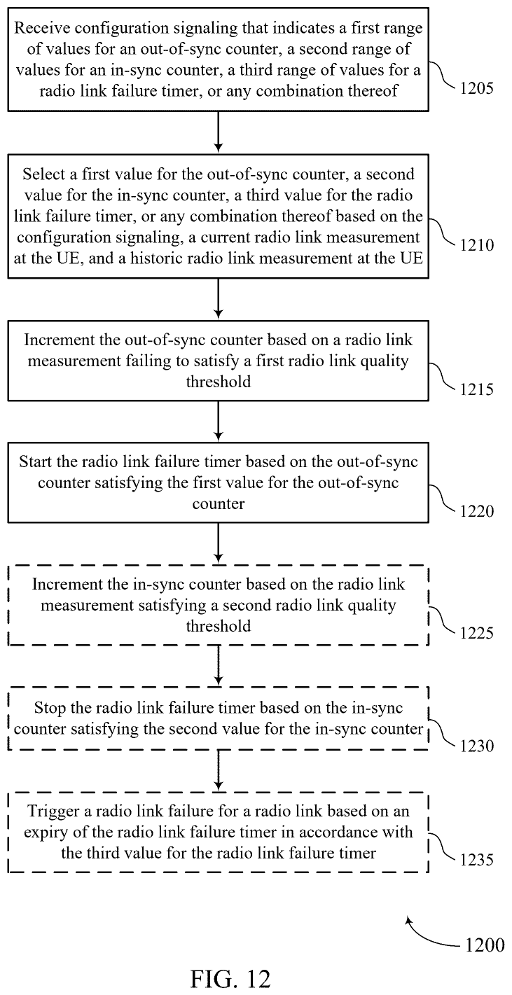

FIG. 12 shows a flowchart illustrating a method 1200 that supports UE-specific radio link failure parameter selection in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving configuration signaling that indicates a first range of values for an out-of-sync counter, a second range of values for an in-sync counter, a third range of values for a radio link failure timer, or any combination thereof. The operations of 1205 may be performed in accordance with examples as disclosed herein, such as the reception of the configuration signaling 220 as described with reference to FIG. 2 or the reception of the configuration signaling at 610 or at 615 as described with reference to FIG. 6. The configuration signaling may include information similar to that described with respect to FIGS. 2 and 6. In some examples, aspects of the operations of 1205 may be performed by a range configuration component 925 as described with reference to FIG. 9.

At 1210, the method may include selecting a first value for the out-of-sync counter, a second value for the in-sync counter, a third value for the radio link failure timer, or any combination thereof based on the configuration signaling, a current radio link measurement at the UE, and/or a historic radio link measurement at the UE. The operations of 1210 may be performed in accordance with examples as disclosed herein, such as the value selection by the UE 115-a as described with reference to FIG. 2, the value selection using an ANN 400 as described with reference to FIG. 4, or the value selection at 620 as described with reference to FIG. 6. The value selection may be based on any combination of parameters described herein with respect to FIGS. 2, 4, and 6. In some examples, aspects of the operations of 1210 may be performed by a value selection component 930 as described with reference to FIG. 9.

At 1215, the method may include incrementing the out-of-sync counter based on a radio link measurement failing to satisfy a first radio link quality threshold. The operations of 1215 may be performed in accordance with examples as disclosed herein, such as the rules for incrementing the out-of-sync counter 225 as described with reference to FIG. 2 or the radio link monitoring procedure based on an out-of-sync metric 310 as described with reference to FIG. 3. In some examples, aspects of the operations of 1215 may be performed by a counter handler 960 as described with reference to FIG. 9.

At 1220, the method may include starting the radio link failure timer based on the out-of-sync counter satisfying the first value for the out-of-sync counter. The operations of 1220 may be performed in accordance with examples as disclosed herein, such as the rules for starting the radio link failure timer 235 as described with reference to FIG. 2 or starting the T310 timer at 315-a and at 315-c as described with reference to FIG. 3. In some examples, aspects of the operations of 1220 may be performed by a timer handler 965 as described with reference to FIG. 9.

In some examples, at 1225, the method may include incrementing the in-sync counter based on the radio link measurement satisfying a second radio link quality threshold. The operations of 1225 may be performed in accordance with examples as disclosed herein, such as the rules for incrementing the in-sync counter 230 as described with reference to FIG. 2 or the radio link monitoring procedure based on an in-sync metric 305 as described with reference to FIG. 3. In some examples, aspects of the operations of 1225 may be performed by a counter handler 960 as described with reference to FIG. 9.

In some examples, at 1230, the method may include stopping the radio link failure timer based on the in-sync counter satisfying the second value for the in-sync counter. The operations of 1230 may be performed in accordance with examples as disclosed herein, such as the rules for stopping the radio link failure timer 235 as described with reference to FIG. 2 or stopping the T310 timer at 315-b as described with reference to FIG. 3. In some examples, aspects of the operations of 1230 may be performed by a timer handler 965 as described with reference to FIG. 9.

In some examples, at 1235, the method may include triggering a radio link failure based on an expiry of the radio link failure timer in accordance with the third value for the radio link failure timer. The operations of 1235 may be performed in accordance with examples as disclosed herein, such as the rules for timer expiry of the radio link failure timer 235 as described with reference to FIG. 2, T310 timer expiry at 315-d as described with reference to FIG. 3, or triggering radio link failure at 645 as described with reference to FIG. 6. In some examples, aspects of the operations of 1235 may be performed by a radio link failure component 940 as described with reference to FIG. 9.

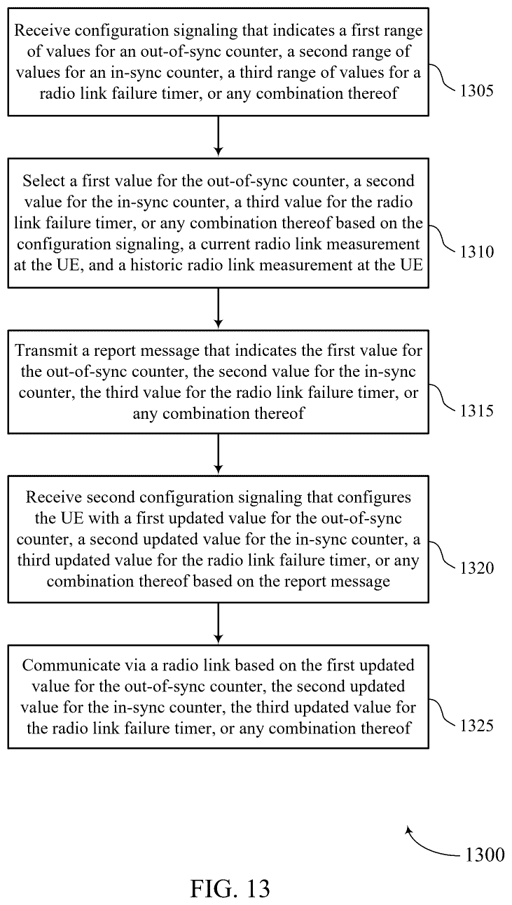

FIG. 13 shows a flowchart illustrating a method 1300 that supports UE-specific radio link failure parameter selection in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include receiving configuration signaling that indicates a first range of values for an out-of-sync counter, a second range of values for an in-sync counter, a third range of values for a radio link failure timer, or any combination thereof. The operations of 1305 may be performed in accordance with examples as disclosed herein, such as the reception of the configuration signaling 220 as described with reference to FIG. 2 or the reception of the configuration signaling at 610 or at 615 as described with reference to FIG. 6. The configuration signaling may include information similar to that described with respect to FIGS. 2 and 6. In some examples, aspects of the operations of 1305 may be performed by a range configuration component 925 as described with reference to FIG. 9.

At 1310, the method may include selecting a first value for the out-of-sync counter, a second value for the in-sync counter, a third value for the radio link failure timer, or any combination thereof based on the configuration signaling, a current radio link measurement at the UE, and/or a historic radio link measurement at the UE. The operations of 1310 may be performed in accordance with examples as disclosed herein, such as the value selection by the UE 115-a as described with reference to FIG. 2, the value selection using an ANN 400 as described with reference to FIG. 4, or the value selection at 620 as described with reference to FIG. 6. The value selection may be based on any combination of parameters described herein with respect to FIGS. 2, 4, and 6. In some examples, aspects of the operations of 1310 may be performed by a value selection component 930 as described with reference to FIG. 9.

At 1315, the method may include transmitting a report message that indicates the first value for the out-of-sync counter, the second value for the in-sync counter, the third value for the radio link failure timer, or any combination thereof. The operations of 1315 may be performed in accordance with examples as disclosed herein, such as the transmission of the UE report 245 as described with reference to FIG. 2 or the UE report transmission at 645 as described with reference to FIG. 6. The report message may include information similar to that described with respect to the UE reports of FIGS. 2 and 6. In some examples, aspects of the operations of 1315 may be performed by a report component 945 as described with reference to FIG. 9.

At 1320, the method may include receiving second configuration signaling that configures the UE with a first updated value for the out-of-sync counter, a second updated value for the in-sync counter, a third updated value for the radio link failure timer, or any combination thereof based on the report message. The operations of 1320 may be performed in accordance with examples as disclosed herein, such as the reception of the configuration signaling 220 as described with reference to FIG. 2 or the reception of the configuration signaling at 630 as described with reference to FIG. 6. The configuration signaling may include information similar to that described with respect to FIGS. 2 and 6. In some examples, aspects of the operations of 1320 may be performed by a value configuration component 950 as described with reference to FIG. 9.

At 1325, the method may include communicating via a radio link based on the first updated value for the out-of-sync counter, the second updated value for the in-sync counter, the third updated value for the radio link failure timer, or any combination thereof. The operations of 1325 may be performed in accordance with examples as disclosed herein, such as the radio link monitoring procedures described with reference to FIG. 2 or the communication at 635 as described with reference to FIG. 6. In some examples, aspects of the operations of 1325 may be performed by a radio link communication component 935 as described with reference to FIG. 9.

The following provides an overview of aspects of the present disclosure:

Aspect 1: A method for wireless communications at a UE, comprising: receiving configuration signaling that indicates a first range of values for an out-of-sync counter, a second range of values for an in-sync counter, a third range of values for a radio link failure timer, or any combination thereof; selecting a first value for the out-of-sync counter, a second value for the in-sync counter, a third value for the radio link failure timer, or any combination thereof based at least in part on the configuration signaling, a current radio link measurement at the UE, and a historic radio link measurement at the UE; and communicating via a radio link based at least in part on the first value for the out-of-sync counter, the second value for the in-sync counter, the third value for the radio link failure timer, or any combination thereof.

Aspect 2: The method of aspect 1, further comprising: triggering a radio link failure for the radio link based at least in part on the first value for the out-of-sync counter, the second value for the in-sync counter, the third value for the radio link failure timer, or any combination thereof.

Aspect 3: The method of aspect 2, further comprising: incrementing the out-of-sync counter based at least in part on a radio link measurement failing to satisfy a first radio link quality threshold; and starting the radio link failure timer based at least in part on the out-of-sync counter satisfying the first value for the out-of-sync counter.

Aspect 4: The method of aspect 3, further comprising: incrementing the in-sync counter based at least in part on the radio link measurement satisfying a second radio link quality threshold; and stopping the radio link failure timer based at least in part on the in-sync counter satisfying the second value for the in-sync counter.

Aspect 5: The method of aspect 3, wherein triggering the radio link failure comprises: triggering the radio link failure based at least in part on an expiry of the radio link failure timer in accordance with the third value for the radio link failure timer.

Aspect 6: The method of any of aspects 1 through 5, further comprising: transmitting a report message that indicates the first value for the out-of-sync counter, the second value for the in-sync counter, the third value for the radio link failure timer, or any combination thereof; and receiving second configuration signaling that configures the UE with a first updated value for the out-of-sync counter, a second updated value for the in-sync counter, a third updated value for the radio link failure timer, or any combination thereof based at least in part on the report message.

Aspect 7: The method of aspect 6, wherein transmitting the report message comprises: transmitting the report message based at least in part on a periodicity, a reporting schedule, a trigger, a prohibit timer, or any combination thereof.

Aspect 8: The method of either of aspects 6 or 7, wherein the report message further indicates one or more performance targets corresponding to the first value for the out-of-sync counter, the second value for the in-sync counter, the third value for the radio link failure timer, or any combination thereof.

Aspect 9: The method of any of aspects 6 through 8, wherein: the report message comprises a first RRC message, a first MAC-CE, a UCI message, or any combination thereof; and the second configuration signaling comprises a second RRC message, a second MAC-CE, a DCI message, or any combination thereof.

Aspect 10: The method of any of aspects 1 through 9, wherein selecting the first value for the out-of-sync counter, the second value for the in-sync counter, the third value for the radio link failure timer, or any combination thereof comprises: inputting, to an AI model, one or more values indicating a set of parameters comprising at least the current radio link measurement, the historic radio link measurement, and the first range of values for the out-of-sync counter, the second range of values for the in-sync counter, the third range of values for the radio link failure timer, or any combination thereof, wherein the AI model outputs an indication of the first value for the out-of-sync counter, the second value for the in-sync counter, the third value for the radio link failure timer, or any combination thereof based at least in part on the input one or more values.

Aspect 11: The method of aspect 10, wherein the set of parameters comprises a first quantity of times the radio link failure timer is started, a second quantity of times the radio link failure timer is reset, a third quantity of times the radio link failure timer expires, a fourth quantity of times the UE switches to an in-sync mode, a first time to trigger radio link failure, a second time that the UE maintains radio link connectivity with a cell, a fifth quantity of times MCG failure occurs, a sixth quantity of times SCG failure occurs, a set of reasons for the radio link failure, a BLER metric, an RSRP metric, or any combination thereof.

Aspect 12: The method of either of aspects 10 or 11, further comprising: training the AI model based at least in part on one or more performance targets for radio link failure.

Aspect 13: The method of any of aspects 10 through 12, further comprising: collecting data associated with the set of parameters; and transmitting a report message that indicates at least a portion of the collected data based at least in part on a network configuration, a periodicity, a reporting scheduled, a trigger, a prohibit timer, or any combination thereof.

Aspect 14: The method of any of aspects 1 through 13, further comprising: receiving third configuration signaling that indicates one or more performance targets for radio link failure, wherein the selecting the first value for the out-of-sync counter, the second value for the in-sync counter, the third value for the radio link failure timer, or any combination thereof is further based at least in part on the one or more performance targets for the radio link failure.

Aspect 15: The method of any of aspects 1 through 14, further comprising: further selecting an evaluation criterion for a BLER metric, an interval time for DRX, a reference signal type for radio link failure determination, a reference signal metric for the radio link failure determination, a radio link failure relaxation criterion, a radio link quality threshold, an additional timer value, an additional counter value, or any combination thereof based at least in part on the current radio link measurement and the historic radio link measurement, wherein the communicating via the radio link is further based at least in part on the further selecting.

Aspect 16: The method of any of aspects 1 through 15, further comprising: receiving fourth configuration signaling that configures the UE to perform flexible selection of the first value for the out-of-sync counter, the second value for the in-sync counter, the third value for the radio link failure timer, or any combination thereof, wherein the selecting the first value for the out-of-sync counter, the second value for the in-sync counter, the third value for the radio link failure timer, or any combination thereof is further based at least in part on the fourth configuration signaling.

Aspect 17: The method of any of aspects 1 through 16, further comprising: transmitting a report message that indicates a UE capability to perform flexible selection of the first value for the out-of-sync counter, the second value for the in-sync counter, the third value for the radio link failure timer, or any combination thereof, wherein the selecting the first value for the out-of-sync counter, the second value for the in-sync counter, the third value for the radio link failure timer, or any combination thereof is further based at least in part on the UE capability.

Aspect 18: The method of any of aspects 1 through 17, wherein the first range of values for the out-of-sync counter, the second range of values for the in-sync counter, the third range of values for the radio link failure timer, or any combination thereof comprises a first threshold value and a second threshold value defining a range of values, a list of possible values defining the range of values, or both.

Aspect 19: A UE for wireless communications, comprising one or more memories storing processor-executable code, and one or more processors coupled with the one or more memories and individually or collectively operable to execute the code to cause the UE to perform a method of any of aspects 1 through 18.

Aspect 20: A UE for wireless communications, comprising at least one means for performing a method of any of aspects 1 through 18.

Aspect 21: A non-transitory computer-readable medium storing code for wireless communications, the code comprising instructions executable by one or more processors to perform a method of any of aspects 1 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration signaling that indicates a first range of values for an out-of-sync counter, a second range of values for an in-sync counter, a third range of values for a radio link failure timer, or any combination thereof;
select a first value for the out-of-sync counter, a second value for the in-sync counter, a third value for the radio link failure timer, or any combination thereof based at least in part on the configuration signaling, a current radio link measurement at the UE, and a historic radio link measurement at the UE; and
communicate via a radio link based at least in part on the first value for the out-of-sync counter, the second value for the in-sync counter, the third value for the radio link failure timer, or any combination thereof.

2. The UE of claim 1, wherein the one or more processors are individually or collectively further operable to execute the code to cause the UE to:
trigger a radio link failure for the radio link based at least in part on the first value for the out-of-sync counter, the second value for the in-sync counter, the third value for the radio link failure timer, or any combination thereof.

3. The UE of claim 2, wherein the one or more processors are individually or collectively further operable to execute the code to cause the UE to:
increment the out-of-sync counter based at least in part on a radio link measurement failing to satisfy a first radio link quality threshold; and
start the radio link failure timer based at least in part on the out-of-sync counter satisfying the first value for the out-of-sync counter.

4. The UE of claim 3, wherein the one or more processors are individually or collectively further operable to execute the code to cause the UE to:
increment the in-sync counter based at least in part on the radio link measurement satisfying a second radio link quality threshold; and
stop the radio link failure timer based at least in part on the in-sync counter satisfying the second value for the in-sync counter.

5. The UE of claim 3, wherein, to trigger the radio link failure, the one or more processors are individually or collectively operable to execute the code to cause the UE to:
trigger the radio link failure based at least in part on an expiry of the radio link failure timer in accordance with the third value for the radio link failure timer.

6. The UE of claim 1, wherein the one or more processors are individually or collectively further operable to execute the code to cause the UE to:
transmit a report message that indicates the first value for the out-of-sync counter, the second value for the in-sync counter, the third value for the radio link failure timer, or any combination thereof; and
receive second configuration signaling that configures the UE with a first updated value for the out-of-sync counter, a second updated value for the in-sync counter, a third updated value for the radio link failure timer, or any combination thereof based at least in part on the report message.

7. The UE of claim 6, wherein, to transmit the report message, the one or more processors are individually or collectively operable to execute the code to cause the UE to:
transmit the report message based at least in part on a periodicity, a reporting schedule, a trigger, a prohibit timer, or any combination thereof.

8. The UE of claim 6, wherein the report message further indicates one or more performance targets corresponding to the first value for the out-of-sync counter, the second value for the in-sync counter, the third value for the radio link failure timer, or any combination thereof.

9. The UE of claim 6, wherein:
the report message comprises a first radio resource control message, a first medium access control element, an uplink control information message, or any combination thereof; and
the second configuration signaling comprises a second radio resource control message, a second medium access control element, a downlink control information message, or any combination thereof.

10. The UE of claim 1, wherein, to select the first value for the out-of-sync counter, the second value for the in-sync counter, the third value for the radio link failure timer, or any combination thereof, the one or more processors are individually or collectively operable to execute the code to cause the UE to:
input, to an artificial intelligence (AI) model, one or more values indicating a set of parameters comprising at least the current radio link measurement, the historic radio link measurement, and the first range of values for the out-of-sync counter, the second range of values for the in-sync counter, the third range of values for the radio link failure timer, or any combination thereof, wherein the AI model outputs an indication of the first value for the out-of-sync counter, the second value for the in-sync counter, the third value for the radio link failure timer, or any combination thereof based at least in part on the input one or more values.

11. The UE of claim 10, wherein the set of parameters comprises a first quantity of times the radio link failure timer is started, a second quantity of times the radio link failure timer is reset, a third quantity of times the radio link failure timer expires, a fourth quantity of times the UE switches to an in-sync mode, a first time to trigger radio link failure, a second time that the UE maintains radio link connectivity with a cell, a fifth quantity of times main cell group failure occurs, a sixth quantity of times secondary cell group failure occurs, a set of reasons for the radio link failure, a block error rate metric, a reference signal received power metric, or any combination thereof.

12. The UE of claim 10, wherein the one or more processors are individually or collectively further operable to execute the code to cause the UE to:
train the AI model based at least in part on one or more performance targets for radio link failure.

13. The UE of claim 10, wherein the one or more processors are individually or collectively further operable to execute the code to cause the UE to:
collect data associated with the set of parameters; and
transmit a report message that indicates at least a portion of the collected data based at least in part on a network configuration, a periodicity, a reporting scheduled, a trigger, a prohibit timer, or any combination thereof.

14. The UE of claim 1, wherein the one or more processors are individually or collectively further operable to execute the code to cause the UE to:
receive third configuration signaling that indicates one or more performance targets for radio link failure, wherein the selecting the first value for the out-of-sync counter, the second value for the in-sync counter, the third value for the radio link failure timer, or any combination thereof is further based at least in part on the one or more performance targets for the radio link failure.

15. The UE of claim 1, wherein the one or more processors are individually or collectively further operable to execute the code to cause the UE to:
further select an evaluation criterion for a block error rate metric, an interval time for discontinuous reception, a reference signal type for radio link failure determination, a reference signal metric for the radio link failure determination, a radio link failure relaxation criterion, a radio link quality threshold, an additional timer value, an additional counter value, or any combination thereof based at least in part on the current radio link measurement and the historic radio link measurement, wherein the communicating via the radio link is further based at least in part on the further selecting.

16. The UE of claim 1, wherein the one or more processors are individually or collectively further operable to execute the code to cause the UE to:
receive fourth configuration signaling that configures the UE to perform flexible selection of the first value for the out-of-sync counter, the second value for the in-sync counter, the third value for the radio link failure timer, or any combination thereof, wherein the selecting the first value for the out-of-sync counter, the second value for the in-sync counter, the third value for the radio link failure timer, or any combination thereof is further based at least in part on the fourth configuration signaling.

17. The UE of claim 1, wherein the one or more processors are individually or collectively further operable to execute the code to cause the UE to:
transmit a report message that indicates a UE capability to perform flexible selection of the first value for the out-of-sync counter, the second value for the in-sync counter, the third value for the radio link failure timer, or any combination thereof, wherein the selecting the first value for the out-of-sync counter, the second value for the in-sync counter, the third value for the radio link failure timer, or any combination thereof is further based at least in part on the UE capability.

18. The UE of claim 1, wherein the first range of values for the out-of-sync counter, the second range of values for the in-sync counter, the third range of values for the radio link failure timer, or any combination thereof comprises a first threshold value and a second threshold value defining a range of values, a list of possible values defining the range of values, or both.

19. A method for wireless communications at a user equipment (UE), comprising:
receiving configuration signaling that indicates a first range of values for an out-of-sync counter, a second range of values for an in-sync counter, a third range of values for a radio link failure timer, or any combination thereof;
selecting a first value for the out-of-sync counter, a second value for the in-sync counter, a third value for the radio link failure timer, or any combination thereof based at least in part on the configuration signaling, a current radio link measurement at the UE, and a historic radio link measurement at the UE; and
communicating via a radio link based at least in part on the first value for the out-of-sync counter, the second value for the in-sync counter, the third value for the radio link failure timer, or any combination thereof.

20. A non-transitory computer-readable medium storing code for wireless communications at a user equipment (UE), the code comprising instructions executable by one or more processors to:
receive configuration signaling that indicates a first range of values for an out-of-sync counter, a second range of values for an in-sync counter, a third range of values for a radio link failure timer, or any combination thereof;
select a first value for the out-of-sync counter, a second value for the in-sync counter, a third value for the radio link failure timer, or any combination thereof based at least in part on the configuration signaling, a current radio link measurement at the UE, and a historic radio link measurement at the UE; and
communicate via a radio link based at least in part on the first value for the out-of-sync counter, the second value for the in-sync counter, the third value for the radio link failure timer, or any combination thereof.
